(19) United States
(12) Patent Application Publication
(10) Pub. No.: US 2017/0208575 A1
(43) Pub. Date: Jul. 20, 2017

(54) LOW LATENCY CONTROL OVERHEAD REDUCTION

(71) Applicant: QUALCOMM Incorporated, San Diego, CA (US)

(72) Inventors: Wanshi Chen, San Diego, CA (US); Yisheng Xue, San Diego, CA (US); Peter Gaal, San Diego, CA (US); Seyedkianoush Hosseini, San Diego, CA (US); Shimman Arvind Patel, San Diego, CA (US)

(21) Appl. No.: 15/402,051

(22) Filed: Jan. 9, 2017

Related U.S. Application Data
(60) Provisional application No. 62/279,985, filed on Jan. 18, 2016.

(51) Int. Cl. H04W 72/04; H04L 5/00

(52) U.S. Cl. CPC H04W 72/0406; H04W 72/0446; H04L 5/0048

(57) ABSTRACT

Systems, methods, and apparatuses for wireless communication are described. Multiple latency modes may be concurrently supported. Available resources and parameters for communication according to one latency mode may be determined with respect to resources used for another latency mode. One of the latency modes may employ transmission time intervals (TTIs) that are shorter in duration relative to the other latency mode. A transport block size or a modulation and coding scheme for shorter duration TTIs may be determined by reference to resources of longer duration TTIs. Multiple shorter duration TTIs may be scheduled in a single grant or may be individually scheduled; or a combination of multi- and individual-TTI scheduling may be employed. Scheduling may be UE-specific and may be dynamically indicated. The scheduling interpretation may depend on the location of a shorter duration TTI with respect to resources of a longer duration TTI.

### CROSS REFERENCES

The present Application for Patent claims priority to U.S. Provisional Patent Application No. 62/279,985, entitled “Low Latency Control Overhead Reduction,” filed Jan. 18, 2016, assigned to the assignee hereof.

### BACKGROUND

The following relates generally to wireless communications and more specifically to control overhead reduction in low latency wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may be otherwise known as user equipment (UE).

Wireless multiple-access technologies have been adopted in various telecommunication standards to provide a common protocol that enables different wireless devices to communicate on a municipal, national, regional, and even global level. An example telecommunication standard is Long Term Evolution (LTE). LTE is designed to improve spectral efficiency, lower costs, improve services, make use of new spectrum, and better integrate with other open standards. LTE may use OFDMA on the downlink (DL), single-carrier frequency division multiple access (SC-FDMA) on the uplink (UL), and multiple-input multiple-output (MIMO) antenna technology. A wireless multiple-access communications system, including a system operating according to the LTE standard, may include a number of base stations, each simultaneously supporting communication for multiple UEs. Uplink control information (UCI) and downlink control information (DCI) may be exchanged between a UE and a base station. UCI and DCI may include data such as acknowledgement data, channel state information (CSI), scheduling information (e.g., assignment information, modulation and coding scheme (MCS)), or the like. UCI may be transmitted from a UE to a base station using a Physical Uplink Control Channel (PUCCH) or a Physical Uplink Shared Channel (PUSCH), while DCI may be transmitted from a base station to a UE using a Physical Downlink Control Channel (PDCCH) or a Physical Downlink Shared Channel (PDSCH), for example.

Rigid resource scheduling for low latency operation or excessive control signaling may limit flexibility in resource allocation and may thus limit support or efficiency of low latency operations. In some applications, latency may be reduced by flexibly and dynamically adapting uplink and downlink resources allocated for transmitting control information (e.g., UCI, DCI) based on data traffic.

### SUMMARY

Systems, methods, and apparatuses for reducing control overhead in systems that support low latency wireless communications are described. For example, a system may concurrently support multiple latency modes, including a low latency mode. Available resources and parameters for communication according to one latency mode (e.g., the low latency mode) may be determined with respect to resources of another latency mode. A low latency mode may employ transmission time intervals (TTIs) that are shorter in duration relative to other latency modes. Parameters of the shorter duration TTIs, including a transport block size (TBS) or a modulation and coding scheme (MCS), may be determined in part by reference to resources of longer duration TTIs.

Multiple shorter duration TTIs may be scheduled in a single grant or may be individually scheduled; or a combination of multi- and individual-TTI scheduling may be employed. Scheduling may be UE-specific and may be dynamically indicated. The interpretation of scheduling information may depend on the location of a shorter duration TTI with respect to resources of a longer duration TTI.

By way of example, a wireless communication system may employ shorter duration TTIs of variable or fixed durations and longer duration TTIs of a different, greater duration. As disclosed herein, each of the shorter duration TTIs may include a single, relatively small, transport block (TB). A multi-TTI grant, which may be received using resources of a longer duration TTI, may indicate a number of scheduled TBs and thus a number of the shorter duration TTIs scheduled by the grant. In other words, a grant received in a control region of a longer duration TTI may schedule one or more shorter duration TTIs, and the interpretation of the grant may depend on a location of the shorter duration TTIs with respect to resources of the longer duration TTI. Additionally or alternatively, a shorter duration TTI may include scheduling information for resources of that TTI or another TTI, or both.

A method of wireless communication is described. The method may include identifying a first TTI having a first duration that comprises two or more symbol periods and identifying a second TTI having a second duration that is less than the first duration. The method may also include determining a parameter of the second TTI based at least in part on a location of the second TTI with respect to the two or more symbol periods of the first TTI and communicating during the second TTI according to the determined parameter of the second TTI.

An apparatus for wireless communication is described. The apparatus may include means for identifying a first TTI having a first duration that comprises two or more symbol periods and means for identifying a second TTI having a second duration that is less than the first duration. The apparatus may also include means for determining a parameter of the second TTI based at least in part on a location of the second TTI with respect to the two or more symbol periods of the first TTI and means for communicating during the second TTI according to the determined parameter of the second TTI.

A further apparatus for wireless communication is described. The apparatus may include a processor, memory in electronic communication with the processor, and instructions stored in the memory. The instructions may be operable to cause the processor to identify a first TTI having a first duration that comprises two or more symbol periods and identify a second TTI having a second duration that is less than the first duration. The instructions may also be operable to cause the processor to determine a parameter of the second TTI based at least in part on a location of the second TTI with respect to the two or more symbol periods of the first TTI and communicate during the second TTI according to the determined parameter of the second TTI.

A non-transitory computer readable medium for wireless communication is described. The non-transitory computer-readable medium may include instructions to cause a processor to identify a first TTI having a first duration that comprises two or more symbol periods and identify a second TTI having a second duration that is less than the first duration. The non-transitory computer-readable medium may also include instructions to cause a processor to determine a parameter of the second TTI based on a location of the second TTI with respect to the two or more symbol periods of the first TTI and communicate during the second TTI according to the determined parameter of the second TTI.

A method of wireless communication is described. The method may include configuring a first TTI having a first duration that comprises two or more symbol periods and configuring a second TTI having a second duration that is less than the first duration. The method may also include configuring a parameter of the second TTI based at least in part on a location of the second TTI with respect to the two or more symbol periods of the first TTI, indicating the parameter to a UE, and communicating during the second TTI according to the configured parameter of the second TTI.

An apparatus for wireless communication is described. The apparatus may include means for configuring a first TTI having a first duration that comprises two or more symbol periods and means for configuring a second TTI having a second duration that is less than the first duration. The apparatus may also include means for configuring a parameter of the second TTI based at least in part on a location of the second TTI with respect to the two or more symbol periods of the first TTI, means for indicating the parameter to a UE, and means for communicating during the second TTI according to the configured parameter of the second TTI.

A further apparatus for wireless communication is described. The apparatus may include a processor, memory in electronic communication with the processor, and instructions stored in the memory. The instructions may be operable to cause the processor to configure a first TTI having a first duration that comprises two or more symbol periods and configure a second TTI having a second duration that is less than the first duration. The instructions may also be operable to cause the processor to configure a parameter of the second TTI based at least in part on a location of the second TTI with respect to the two or more symbol periods of the first TTI, indicate the parameter to a UE, and communicate during the second TTI according to the configured parameter of the second TTI.

A non-transitory computer readable medium for wireless communication is described. The non-transitory computer-readable medium may include instructions to cause a processor to configure a first TTI having a first duration that comprises two or more symbol periods and configure a second TTI having a second duration that is less than the first duration. The non-transitory computer-readable medium may also include instructions to cause a processor to configure a parameter of the second TTI based on a location of the second TTI with respect to the two or more symbol periods of the first TTI, indicate the parameter to a UE, and communicate during the second TTI according to the configured parameter of the second TTI.

In some examples of the method, apparatus, and non-transitory computer-readable medium described above, the determined parameter of the second TTI comprises a transport block size or a modulation and coding scheme, or both.

In some examples of the method, apparatus, and non-transitory computer-readable medium described above, a single transport block spans the second duration of the second TTI.

Some examples of the method, apparatus, and non-transitory computer-readable medium described above may further include processes, features, means, or instructions for identifying an index for each symbol period of the two or more symbol periods of the first TTI, wherein the parameter of the second TTI may be determined based at least in part on the location of the second TTI with respect to at least one of the identified indices.

Some examples of the method, apparatus, and non-transitory computer-readable medium described above may further include processes, features, means, or instructions for determining that a symbol associated with the first TTI overlaps in time with the second TTI and comprises a reference signal, wherein the parameter of the second TTI may be determined based at least in part on the determination that the symbol associated with the first TTI comprises the reference signal.

Some examples of the method, apparatus, and non-transitory computer-readable medium described above may further include processes, features, means, or instructions for receiving a configuration message that identifies the symbol associated with the first TTI that comprises the reference signal.

In some examples of the method, apparatus, and non-transitory computer-readable medium described above, the parameter of the second TTI may be determined based at least in part on a symbol associated with the first TTI comprising a control message.

Some examples of the method, apparatus, and non-transitory computer-readable medium described above may further include processes, features, means, or instructions for receiving a first control message in a control region of the first TTI, wherein the first control message schedules resources during the second TTI or a third TTI, or both. Some examples of the method, apparatus, and non-transitory computer-readable medium described above may further include processes, features, means, or instructions for communicating during the second TTI or the third TTI, or both, using resources scheduled by the first control message.

Some examples of the method, apparatus, and non-transitory computer-readable medium described above may further include processes, features, means, or instructions for receiving a second control message during the second TTI, wherein the second control message schedules resources during the second TTI. Some examples of the method, apparatus, and non-transitory computer-readable medium described above may further include processes, features, means, or instructions for communicating during the second TTI using resources scheduled by the second control message.

In some examples of the method, apparatus, and non-transitory computer-readable medium described above, the first control message schedules resources during the second TTI and the third TTI. In some examples of the method, apparatus, and non-transitory computer-readable medium described above, the second TTI and the third TTI each comprise portions of a same transport block.

In some examples of the method, apparatus, and non-transitory computer-readable medium described above, the first control message schedules resources during the second TTI and the third TTI. In some examples of the method, apparatus, and non-transitory computer-readable medium described above, the second TTI comprises a first repetition of a transport block and the third TTI comprises a second repetition of the transport block.

Some examples of the method, apparatus, and non-transitory computer-readable medium described above may further include processes, features, means, or instructions for receiving a configuration message that indicates that the first control message schedules resources of the second TTI or the third TTI, or both. Some examples of the method, apparatus, and non-transitory computer-readable medium described above may further include processes, features, means, or instructions for monitoring the control region of the first TTI for the first control message based at least in part on receiving the configuration message.

Some examples of the method, apparatus, and non-transitory computer-readable medium described above may further include processes, features, means, or instructions for receiving a configuration message that indicates a number of second TTIs that may have the second duration that occurs within the first duration of the first TTI.

Some examples of the method, apparatus, and non-transitory computer-readable medium described above may further include processes, features, means, or instructions for identifying a third TTI having a third duration that may be less than the first duration. Some examples of the method, apparatus, and non-transitory computer-readable medium described above may further include processes, features, means, or instructions for determining a parameter of the third TTI based at least in part on a location of the third TTI with respect the two or more symbol periods of the first TTI. Some examples of the method, apparatus, and non-transitory computer-readable medium described above may further include processes, features, means, or instructions for communicating during the third TTI according to the determined parameter of the third TTI.

In some examples of the method, apparatus, and non-transitory computer-readable medium described above, a control message that schedules the second TTI and the third TTI comprises a first indicator that the second TTI comprises new data and a second indicator that the third TTI comprises other new data.

In some examples of the method, apparatus, and non-transitory computer-readable medium described above, a control message that schedules the second TTI and the third TTI comprises a common indicator that either the second TTI or the third TTI, or both, include new data.

Some examples of the method, apparatus, and non-transitory computer-readable medium described above may further include processes, features, means, or instructions for receiving a configuration message that indicates a number of TTIs having the second duration and a number of TTIs having the third duration that occur within the first duration of the first TTI.

Some examples of the method, apparatus, and non-transitory computer-readable medium described above may further include processes, features, means, or instructions for receiving a message that schedules resources for periodic transmissions, wherein resources scheduled for each transmission opportunity comprise two or more TTIs having the second duration, and wherein a single transport block spans the second duration of each TTI of the two or more TTIs.

Some examples of the method, apparatus, and non-transitory computer-readable medium described above may further include processes, features, means, or instructions for transmitting a negative acknowledgment message for data associated with the second TTI. Some examples of the method, apparatus, and non-transitory computer-readable medium described above may further include processes, features, means, or instructions for monitoring for a retransmission of the data associated with the second TTI according to a fixed retransmission timing.

### BRIEF DESCRIPTION OF THE DRAWINGS

FIG. 1 illustrates an example of a wireless communications system that supports low latency control overhead reduction in accordance with aspects of the present disclosure;

FIG. 2 illustrates an example of a wireless communications system that supports low latency control overhead reduction in accordance with aspects of the present disclosure;

FIG. 3 illustrates an example of multiple transmission time intervals (TTIs) that support low latency control overhead reduction in accordance with aspects of the present disclosure;

FIG. 4 illustrates an example of a process flow in a system that supports low latency control overhead reduction in accordance with aspects of the present disclosure;

FIGS. 5 through 8 show block diagrams of a wireless device that supports low latency control overhead reduction in accordance with aspects of the present disclosure;

FIGS. 9 through 11 show block diagrams of a wireless device that supports low latency control overhead reduction in accordance with aspects of the present disclosure; and

FIGS. 13 through 17 illustrate methods for low latency control overhead reduction in accordance with aspects of the present disclosure.

### DETAILED DESCRIPTION

Certain wireless communication applications may be bursty in nature. A particular user equipment (UE) may, for example, operate a relatively long period without sending or receiving data, and then a relatively large amount, or burst, of data may queue up for transmission to or from the UE. The data may be associated with a latency sensitive application, such as a vehicle communication system, a gaming application, or another implementation that is delay intolerant. A base station may be aware of such bursty downlink (DL) data (e.g., mobile-terminated data arriving at the base station) and may predict both channel conditions and an expected number of low latency transmissions to use to send the data to the UE. The base station may thus reduce signaling overhead and efficiently allocate resources by concurrently scheduling multiple low latency TTIs.

Likewise, a base station can predict a number of low latency uplink (UL) TTIs that may be used by a UE. For example, based on a buffer status report (BSR) and UL channel conditions, a base station may predict a number of UL TTIs that may be needed. The base station may thus concurrently schedule the UL TTIs.

Such reductions in signaling overhead (e.g., by concurrently scheduling multiple low latency TTIs) may be achieved by explicit or implicit identification of available resources. As described herein, available resources and parameters for communication using low latency TTIs may be determined with respect to resources of other, longer duration TTIs. A wireless communications system may configure low latency TTIs to support concurrent operation with longer duration TTIs. For instance, resource availability for low latency data transmissions may be symbol dependent. Whether a symbol of longer duration TTI includes a cell-specific reference signal (CRS) may affect resource availability for a low latency TTI. In some cases, a modulation and coding scheme (MCS) may depend on or be adjusted to accommodate a bursty assignment in multiple TTIs.

By way of example, a manner of discerning resource availability for low latency data transmissions may be indicated with radio resource control (RRC) signaling or may be hard-coded. For instance, different symbol types in a longer duration subframe may indicate low latency resource availability. Symbols may be designated by whether they are in a control region, are in a data region, and/or include CRS. As described below, whether a symbol is in a control or data region, or includes CRS, may affect a UE's identification of whether overlapping low latency resources are available.

Similarly, different MCSs may be determined for different symbol types within a bursty assignment (i.e., a multi-TTI assignment). For example, each symbol may be associated with some parameters. One symbol type may use quadrature phase shift keying (QPSK) modulation and a first resource block scaling factor (e.g., for TBS lookup), while another symbol type may have a second resource block scaling factor and/or MCS. Still other symbol types may have a fixed scaling factor. Additionally or alternatively, symbols carrying a grant may be treated differently from other symbols. A symbol or TTI that carries control information may have special TBS handling. Symbols may thus be categorized with subtypes depending on their respective characteristics. As described herein, such characteristics may affect parameters of low latency TTIs.

Aspects of the disclosure introduced above are described below in the context of a wireless communication system. A wireless communication system may include a base station and a UE that support low latency applications and multi-TTI operations as described herein. A physical layer (PHY) and corresponding description of radio frame structures, as described herein, may also be used by a base station and UE for control overhead reductions. Aspects of the disclosure are further illustrated by and described with reference to apparatus diagrams, system diagrams, and flowcharts that relate to low latency control overhead reduction.

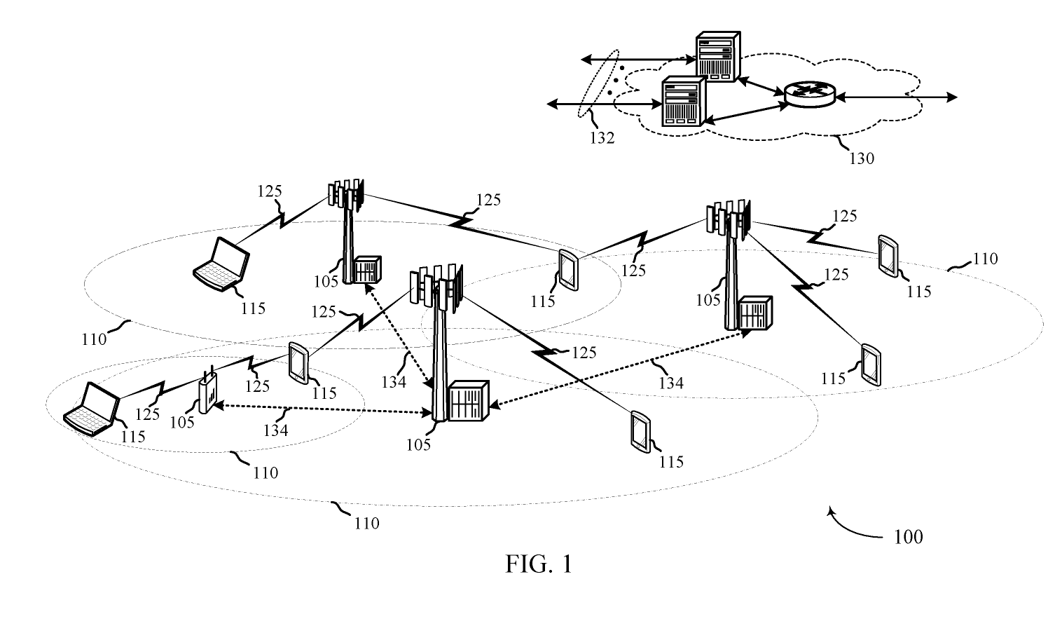

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. The wireless communications system 100 may support low latency applications and multi-TTI operations as described herein. Additionally, the wireless communications system 100 may support control overhead reduction for low latency applications and multi-TTI operations.

Base stations 105 may wirelessly communicate with UEs 115 via one or more base station antennas. Each base station 105 may provide communication coverage for a respective geographic coverage area 110. Communication links 125 shown in wireless communications system 100 may include UL transmissions from a UE 115 to a base station 105, and/or DL transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, or like terminology. A UE 115 may also be a cellular phone, a wireless modem, a handheld device, a personal computer, a tablet, a personal electronic device, a machine type communication (MTC) device, etc.

Base stations 105 may communicate with the core network 130 and with one another. For example, base stations 105 may interface with the core network 130 through backhaul links 132 (e.g., Si). Base stations 105 may communicate with one another over backhaul links 134 (e.g., X2) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as eNodeBs (eNBs) 105.

Data communications within wireless communications system 100 may be divided into and described with reference to logical channels, transport channels, and physical (PHY) layer channels. Channels may also be classified into control channels and traffic channels. Logical control channels may include a paging control channel (PCCH) for paging information, a broadcast control channel (BCCH) for broadcast system control information, a multicast control channel (MCCH) for transmitting multimedia broadcast/multicast service (MBMS) scheduling and control information, a dedicated control channel (DCCH) for transmitting dedicated control information, a common control channel (CCCH) for random access information, a dedicated traffic channel (DTCH) for dedicated UE data, and a multicast traffic channel (MTCH) for multicast data.

DL transport channels may include a broadcast channel (BCH) for broadcast information, a downlink shared channel (DL-SCH) for data transfer, a paging channel (PCH) for paging information, and a multicast channel (MCH) for multicast transmissions. UL transport channels may include a random access channel (RACH) for access and an uplink shared channel (UL-SCH) for data.

DL PHY channels may include a physical broadcast channel (PBCH) for broadcast information, a physical control format indicator channel (PCFICH) for control format information, a physical downlink control channel (PDCCH) for control and scheduling information, a physical hybrid automatic repeat request (HARQ) indicator channel (PHICH) for HARQ status messages, a physical downlink shared channel (PDSCH) for user data, and a physical multicast channel (PMCH) for multicast data. UL PHY channels may include a physical random access channel (PRACH) for access messages, a physical uplink control channel (PUCCH) for control data, and a physical uplink shared channel (PUSCH) for user data.

The PDCCH carries downlink control information (DCI) in at least one control channel element (CCE), which may consist of nine logically contiguous resource element groups (REGs), where each REG contains 4 resource elements (REs). DCI includes information regarding DL scheduling assignments, UL resource grants, transmission scheme, UL power control, HARQ information, MCS and other information. The size and format of the DCI messages can differ depending on the type and amount of information that is carried by the DCI.

The PDCCH can carry DCI messages associated with multiple users, and each UE 115 may decode the DCI messages that are intended for it. For example, each UE 115 may be assigned a cell radio network temporary identifier (C-RNTI), and cyclic redundancy check (CRC) bits attached to each DCI may be scrambled based on the C-RNTI. To reduce power consumption and overhead at the UE, a limited set of CCE locations can be specified for DCI associated with a specific UE 115. CCEs may be grouped (e.g., in groups of 1, 2, 4 and 8 CCEs), and a set of CCE locations in which the UE may find relevant DCI may be specified. A UE 115 may attempt to decode DCI by performing a process known as a blind decode. Multi-TTI scheduling (e.g., a multi-TTI grant) may be transmitted using the PDCCH, and such scheduling may be UE-specific. In some cases, a control portion of a low latency TTI may include a low latency PDCCH (uPDCCH), which may include a multi- or individual-TTI grant.

Time intervals for communication within wireless communications system 100 may be expressed in multiples of a basic time unit (e.g., the sampling period, Ts=1/30,720,000 seconds). Time resources may be organized according to radio frames of length of 10 ms (Tf=307200 Ts), which may be identified by a system frame number (SFN) ranging from 0 to 1023. Each frame may include ten 1 ms subframes numbered from 0 to 9. A subframe may be further divided into two 0.5 ms slots, each of which contains two or more modulation symbol periods (depending on the length of the cyclic prefix (CP) prepended to each symbol). Excluding the CP, each symbol contains 2048 sample periods. In some cases the subframe may be the smallest scheduling unit, also known as a TTI. But the wireless communications system 100 may support TTIs having a duration of one subframe as well as shorter duration, or lower latency TTIs, which may have a duration of less than one LTE subframe (e.g., one symbol period, two symbol periods, one slot, etc.). In various examples, wireless communications system 100 supports two or more TTI durations—including a first duration that is at least two LTE symbol periods in duration, and one or more durations that are less than the first duration.

Within wireless communications system 100, short duration TTIs may be fixed in duration and may include a single transport block (TB). In some cases a single TB may span multiple TTIs. A transport block (TB) is a unit of data passed between logical layers of a communications system. For example, the transport block may refer to a unit of data passed between the medium access control (MAC) and PHY layers and may include data and header information for various logical layers of the communication system (e.g., radio link control (RLC), MAC, etc.). By way of example, a TB may span the length (i.e., duration) of one or more low latency TTIs. So, a determination of a number of scheduled TBs may indicate a number of scheduled low latency TTIs.

A base station 105 may insert periodic pilot symbols (e.g., a CRS) to aid UEs 115 in channel estimation and coherent demodulation, and thus communication with wireless communications system 100. A CRS may include one of 504 different cell identities, for instance. They may be modulated using QPSK and power boosted (e.g., transmitted at 6 dB higher than the surrounding data elements) to make them resilient to noise and interference. A CRS may be embedded in 4 to 16 REs in each resource block (RB) based on the number of antenna ports or layers (e.g., up to 4) of the receiving UEs 115. In addition to a CRS, which may be utilized by all UEs 115 in the coverage area 110 of the base station 105, a demodulation reference signal (DMRS) may be directed toward specific UEs 115 and may be transmitted on RBs assigned to that UEs 115. A determination of low latency TTI parameters may be based on, or may depend on, whether a CRS is present in a symbol.

Wireless communications system 100 may employ HARQ, a method of increasing the likelihood that data is received correctly over a wireless communication link 125. HARQ may include a combination of error detection (e.g., using a CRC), forward error correction (FEC), and retransmission (e.g., automatic repeat request (ARQ)). HARQ may improve throughput at the MAC layer in poor radio conditions (e.g., signal-to-noise conditions). In Incremental Redundancy HARQ, incorrectly received data may be stored in a buffer and combined with subsequent transmissions to improve the overall likelihood of successfully decoding the data. In some cases, redundancy bits are added to each message prior to transmission. This may be useful in poor conditions. In other cases, redundancy bits are not added to each transmission, but are retransmitted after the transmitter of the original message receives a negative acknowledgement (NACK) indicating a failed attempt to decode the information. The chain of transmission, response, and retransmission may be referred to as a HARQ process. In some cases, a limited number of HARQ processes may be used for a given communication link 125.

In some examples, HARQ processes may be performed at a transport block level, in which the entire transport block is retransmitted when a NACK is received by the transmitter. In a multi-TTI assignment, separate indicators for new data may be used for each TB in the assignment. Or, in some examples, a single new data indicator may be used for all TBs of the assignment. In other cases, multi-TTI scheduling may be used for new transmissions only, such that retransmission may, in some examples, be limited to individual assignments.

In some examples, a TB may be divided into one or more code blocks and HARQ processes may be performed at a code block level where one or more code blocks (e.g., the one or more code blocks that were unsuccessfully decoded by the receiver) are retransmitted when a NACK is received by the transmitter. The threshold for code block level HARQ processes for low latency TTIs may be different from longer duration TTIs (e.g., it might be different from 6144 bits, as is in LTE).

Some examples may employ partially synchronous HARQ operation. For instance, when multi-TTI scheduling is used, a UE 115 may, based on whether each TB is successfully decoded or not, look for a re-transmission using a fixed timing for unsuccessfully decoded transmissions. Such a process may not rely on a control channel.

In some cases, wireless communications system 100 may utilize one or more enhanced component carrier (eCCs). An eCC may be characterized by one or more features including: flexible bandwidth, different TTI durations, and modified control channel configuration. In some cases, an eCC may be associated with a carrier aggregation (CA) configuration or a dual connectivity configuration (e.g., when multiple serving cells have a suboptimal backhaul link 132 and/or 134). An eCC may also be configured for use in unlicensed spectrum or shared spectrum (e.g., where more than one operator is licensed to use the spectrum). An eCC characterized by flexible bandwidth may include one or more frequency ranges that may be utilized by UEs 115 that are not capable of monitoring the whole bandwidth or prefer to use a limited bandwidth (e.g., to conserve power).

In some cases, an eCC may utilize a different TTI length than other CCs, which may include use of a reduced or variable symbol duration as compared with TTIs of the other CCs. The symbol duration may remain the same, in some cases, but each symbol may represent a distinct TTI. In some examples, an eCC may support transmissions using different TTI lengths, and a parameter of a shorter duration TTI of the eCC may be determined with reference to resources of a longer duration TTI within wireless communications system 100.

Wireless communications system 100 may concurrently support multiple latency modes. Available resources and parameters for communication according to one latency mode of wireless communications system 100 may be determined with respect to resources used for another latency mode of wireless communications system 100. A UE 115 may determine a TBS and/or MCS for shorter duration TTIs within wireless communications system 100 by reference to resources of longer duration TTIs of wireless communications system 100. A base station 105 may schedule multiple shorter duration TTIs, each comprising a single TB, in a single grant. Scheduling may be UE-specific and may be dynamically indicated. A UE 115 may interpret scheduling based on the location of a shorter duration TTI with respect to resources of a longer duration TTI.

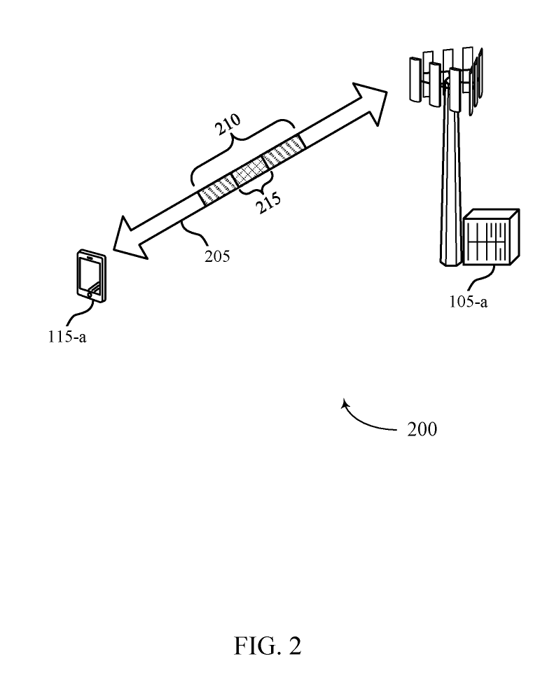

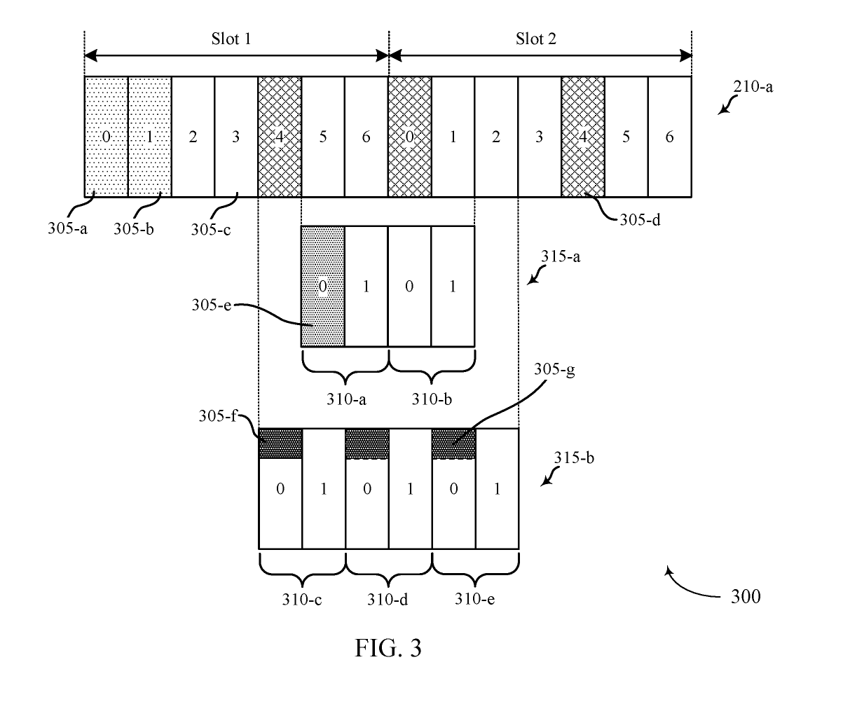

FIG. 2 illustrates an example of a wireless communications system 200 that supports low latency control overhead reduction. Wireless communications system 200 may include base station 105-a and UE 115-a, which may be examples of the corresponding devices described with reference to FIG. 1. Wireless communications system 200 may illustrate aspects of wireless communications system 100. For instance, wireless communications system 200 may include UE 115-a and a base station 105-a, which may be examples of a UE 115 or base station 105 described with reference to FIG. 1. Base station 105-a may communicate with UE 115-a via communication link 205 (e.g., to reduce control overhead), as described with reference to FIG. 1

A frame structure may be used within the wireless communications system 200 to organize physical resources. A frame may be a 10 ms interval that may be further divided into 10 equally sized subframes. Each subframe may include two consecutive time slots. Each slot may include 6 or 7 OFDMA symbol periods. A resource element consists of one symbol period and one subcarrier (e.g., a 15 kHz frequency range). A resource block may contain 12 consecutive subcarriers in the frequency domain and, for a normal cyclic prefix in each OFDM symbol, 7 consecutive OFDM symbols in 1 slot (84 resource elements) in the time domain. Some resource elements may include a DL reference signal (DL-RS). The DL-RS may include a CRS and DMRS as described above. The number of bits carried by each RE may depend on the MCS. Thus, the more RBs that a UE 115 receives and/or the higher the MCS, the higher the data rate may be for the UE 115. Further details of TTIs that may be utilized by wireless communications system 200 are illustrated by and described with reference to FIG. 3.

In some cases, fixed length TTI 210 may be an LTE subframe. When multiple transport blocks occur within a fixed length TTI 210, each TTI corresponding to the multiple TBs may be shorter than TTI 210. TTI 215 may have a length (i.e., duration) shorter than fixed length TTI 210. TTI 215 may include a single TB that spans the length of TTI 215. In some cases, the number of scheduled TBs may be dynamically selected and indicated to a UE 115-a, which may then discern a number of TTIs 215 that are scheduled.

TTIs 215 with short durations may be employed for low latency operations. In some cases, using shorter length TTIs may reduce over-the-air latency. For example, shorter TTIs 215 (e.g., on the order of an LTE symbol period, two symbol periods, one slot, etc.) may help reduce HARQ latency as compared with non-low latency TTIs (e.g., an LTE subframe).

In some cases, low latency scheduling may be done in two stages. With a two-stage control channel, a stage 0 grant may provide less dynamic scheduling parameters, while a stage 1 grant may provide more dynamic scheduling parameters (e.g., for low latency delay). For example, a two-stage control channel may be implemented with a stage 0 grant in PDCCH of TTI 210, where the stage 0 grant indicates some parameter of TTIs 215, and then a stage 1 grant in uPDCCH of TTI 215 may indicate dynamic aspects of TTI 215. So control information may be transmitted in a control region in one or more symbols of TTI 215 in addition to a control region (e.g., the first several symbols) of TTI 210. A bursty length (e.g., a number of TTIs 215) may be dynamically indicated with a control channel in DCI.

In some cases, a set of bursty lengths for multi-TTI scheduling may be RRC configured. For example, an RRC configuration message may indicate 1 TTI, 2 TTIs, 3 TTIs, 4 TTIs, 7 TTIs, or a number of TTIs until the end of a subframe using a three-bit indicator. In some examples, an RRC configuration message may indicate 1 TTI, 2 TTIs, 7 TTIs, or a number of TTIs until the end of a subframe using a two-bit indicator.

In some examples, semi-persistent scheduling (SPS) may be employed. In SPS, a base station 105-a may transmit scheduling information to a given UE 115-a based on a periodicity and a temporary identifier (e.g., a radio network temporary identifier (RNTI), a cell specific RNTI (C-RNTI), an SPS C-RNTI, etc.). In such cases, multiple UEs 115 may share resources (or share at least a portion of the same resources), but may be assigned access to the shared resources at different times. Therefore, instead of separately scheduling resources of every UE 115 for each data transmission, data transmissions may be scheduled for multiple UEs 115 sharing resources at different times (e.g., periodically).

SPS may be used in addition to the multi-TTI scheduling described herein to reduce control overhead. For example, SPS can be used to activate/deactivate multi-TTI scheduling, and UE 115-a may identify a bursty length in an SPS activation message. SPS configuration may be periodic, and in each transmission opportunity, the transmission can be for multiple TTIs (e.g., multiple TBs).

Contention-based scheduling may be employed to reduce latency for communication in portions of the radio frequency spectrum used by licensed wireless providers. That is, multiple UEs 115 operating in so-called licensed spectrum may be assigned the same set of resources (or overlapping resources), and may perform a contention procedure when the UEs 115 have data to transmit. This may allow for more frequently occurring SPS periods because assigning resources to one UE 115-a does not preclude the possibility of assigning the same resources to another UE 115. Various techniques for control information handling, UE identification, and resource monitoring may be employed to facilitate efficient contention-based scheduling. Contention-based scheduling may be used in addition to multi-TTI scheduling described herein to reduce control overhead.

In some cases, control-less data transmission may be utilized in order to address low latency control overhead. For example, data—such as small UL data transmissions—may be transmitted without an associated low latency control channel. Additionally or alternatively, multi-TTI scheduling may be employed for larger UL data transmissions to further reduce overhead.

In other cases, TTI length (e.g., number of symbols within the TTI) may by dynamically indicated for different data transmissions. For example, a low latency control channel may schedule resources for each data transmission by varying the number of symbols of the TTI (i.e., TTI length). Dynamic TTI length indication may be employed in wireless communications system 200 in certain scenarios, while multi-TTI scheduling (e.g., scheduling multiple, fixed-length low latency TTIs) may be employed in other scenarios and according to particular parameters associated with UE 115-a.

Base station 105-a may insert periodic pilot symbols such as CRS in DL transmissions to aid UE 115-a in channel estimation and coherent demodulation. CRS may include one of 504 different cell identities. In addition to CRS, which may be utilized by all UEs 115 in the coverage area of the base station 105-a, DMRS may be directed toward specific UEs 115 and may be transmitted on resource blocks assigned to those UEs 115. Determination of parameters of TTI 215 may depend on CRS locations within TTI 210.

FIG. 3 illustrates various resources 300, including multiple TTIs, that support low latency control overhead reduction. In some cases, the multiple TTIs and corresponding frame structures represent aspects of resources used by a UE 115 or base station 105 as described with reference to FIGS. 1-2. In FIG. 3, a TTI 210-a is shown having 14 symbols spanning the duration of TTI 210-a. The TTI 210-a duration may be subdivided into two slots, each having 7 symbols indexed 0 through 6. The TTI 210-a may include one or more symbols allocated as a control region. For example, as shown in FIG. 3, TTI 210-a includes a first portion (in this case, symbols 305-a and 305-b) allocated as a control region and containing control information. The control region may also include a CRS. The first portion may include more or fewer than two symbols in some cases, and the number of symbols of the control region may be indicated to a UE 115. For example, the first portion may include 3, 4, or 5 symbols allocated for control information.

The control information of symbols 305-a or 305-b, for example, may include scheduling information for TTI 210-a and other TTIs. For example, multiple UEs 115 may communicate during TTI 210-a and resources of the symbols within TTI 210-a may be assigned to each of the multiple UEs 115. As shown, TTI 210-a includes additional symbols, such as symbol 305-c, for transmitting information other than control information (e.g., for transmission of data). In addition, TTI 210-a may also include one or more symbols allocated for reference signals, such as a CRS, as indicated by symbol 305-d. As shown, symbol 4 of the first slot of TTI 210-a and symbols 0 and 4 of the second slot of TTI 210-a are allocated for CRS. In some cases, the CRS is included in a control region (e.g., symbol 305-a and/or symbol 305-b).

In some examples, multiple TTIs of a shorter duration than TTI 210-a may be scheduled. Each of the multiple TTIs may correspond to a TB and may overlap in time with some portion of TTI 210-a. For example, as shown in FIG. 3, multiple TTIs 310 may each have a duration shorter than that of TTI 210-a and may span at least a portion of TTI 210-a. Based on a location (e.g., a starting time) of one or more of the multiple TTIs 310 with respect to resources of TTI 210-a, parameters of the TTIs 310 (e.g., TB size, MCS) may be determined.

As illustrated by multi-TTI 315-a, two TBs may be exchanged between a UE (e.g., UE 115 in FIG. 1 or 2) and a base station (e.g., base station 105 in FIG. 1 or 2) during TTIs 310-a and 310-b, with each of TTIs 310-a and 310-b including one TB. In some examples, and as illustrated, TTIs 310-a and TTI 310-b may each include two symbol periods indexed 0 through 1 and may collectively span a portion of or the entirety of TTI 210-a.

In some examples, scheduling information for each of the TTIs 310-a and 310-b may be transmitted in symbols 305-a and 305-b. The control information in symbols 305-a and 305-b may include TBS, the number of TTIs or transport blocks, or the MCS for multi-TTI 315-a. The transport block size or the MCS for each of TTIs 310-a and 310-b may be determined based on a location (e.g., a starting time) of the first of two TTIs 310-a and 310-b (in this case, the first TTI is TTI 310-a). For example, the location of TTI 310-a may not overlap TTI 210-a until after the first 5 symbol periods of TTI 210-a, as shown. Thus, determining control information for TTIs 310-a and 310-b may depend on the location of the multi-TTI 315-a, the number of TTIs of multi-TTI 315-a, the number of symbols of TTI 210-a subsequent to the starting time for multi-TTI 315-a, or the number of symbols of multi-TTI 315-a that overlap symbols within TTI 210-a. Additionally or alternatively, control information for TTIs 310-a and 310-b may be transmitted in a first symbol of TTI 310-a, as shown by symbol 305-e. Thereafter, one of the two transport blocks may be transmitted during TTI 310-a, while the other of the two transport blocks may be transmitted during TTI 310-b. In some cases, a single TB may span TTI 310-a and TTI 310-b. Alternatively, the TTI 310-a and TTI 310-b may contain copies of the same TB (e.g., for a scenario in which channel conditions are poor).

In another example, as illustrated by multi-TTI 315-b, three transport blocks corresponding to TTIs 310-c, 310-d, and 310-e may be exchanged between a UE 115 and a base station 105. TTIs 310-c, 310-d, and 310-e may each include two symbol periods indexed 0 through 1 and may collectively span a portion of or the entirety of TTI 210-a.

In some examples, scheduling information for each of the TTIs 310-c, 310-d, and 310-e may be transmitted in symbols 305-a and 305-b allocated for control information as shown in TTI 210-a. The control information in symbols 305-a and 305-b may include transport block size, the number of TTIs or transport blocks, or the MCS for multi-TTI 315-b. The transport block size or the MCS for each of TTIs 310-c, 310-d, and 310-e may be determined based on a location (e.g., a starting time) of the first of the three TTIs 310-c, 310-d, and 310-e (in this case, the first TTI is TTI 310-c). For example, the location of TTI 310-c may not overlap TTI 210-a until after the first 4 symbol periods of TTI 210-a, as shown. Thus, determining control information for TTIs 310-c, 310-d, and 310-e may depend on the location of the multi-TTI 315-b, the number of TTIs of multi-TTI 315-b, the number of symbols of TTI 210-a subsequent to the starting time for multi-TTI 315-b, or the number of symbols of multi-TTI 315-b that overlap symbols within TTI 210-a.

Additionally or alternatively, control information for TTIs 310-c, 310-d, and 310-e may be transmitted in a portion of a first symbol of TTI 310-c, as shown by 305-f. In some examples, control information for each of TTIs 310-c, 310-d, and 310-e may be transmitted in their respective TTIs. For example, control information for TTI 310-c may be transmitted in 305-f, control information for TTIs 310-d and 310-e may be transmitted in the first symbol (or at least a portion of the first symbol) in each of TTIs 310-d and 310-e. As illustrated by 305-g, control information for TTI 310-e may be transmitted within a portion of the first symbol of TTI 310-e. Thereafter, one of the three transport blocks may be transmitted during TTI 310-c, while the others may be transmitted during TTI 310-d and TTI 310-e.

While TTI 210-a is shown allocating symbols 305-a and 305-b for control information, in some cases, control information for multi-TTI operations may be included in one or more symbols of a TTI in a multi-TTI (e.g., multi-TTI 315-a and/or 315-b). As such, scheduling information may be determined for multi-TTI operations based on location (e.g., starting time) with respect to symbols of the TTI 210-a, but may be transmitted in portions allocated for control information in a multi-TTI, such as symbol 305-e in TTI 310-a.

In some examples, both variable TTI and multi-TTI operations may be considered in a wireless communication system. In such a system, choosing whether to utilize variable TTI or multi-TTI operation may be based on channel conditions. For example, if frequency-selectivity based scheduling is considered, variable TTI with a single transport block may be used (e.g., to exploit frequency selectivity gain). If the channel is time-varying and channel feedback is accurate, multi-TTI may be used (e.g., to exploit rate adaptation gain). Accordingly, though shown as containing two symbols, low latency TTIs 310 may have any suitable number of symbols (e.g., fewer than 7). Further, the low latency TTIs 310 within a single multi-TTI may not have the same number of symbols (e.g., TTI 310-d may contain three symbols instead of two in some cases). Further, though shown as spanning slot 1 and slot 2, in some cases a multi-TTI 315 may be contained within a single slot. As an example, multi-TTI 315-b may completely overlap in time with slot 2, such that TTI 310-c overlaps with symbols 0 and 1 of slot 2, TTI 310-d overlaps with symbols 2, 3, and 4, and TTI 310-e overlaps with symbols 5 and 6. Other implementations are also possible (e.g., TTI 310-c may contain three symbols in other cases, etc.).

If the size allocated for control information in symbol 305-a, for example, is different from the size allocated for control information in symbol 305-f, the number of blind decodes for the low latency control channel may increase. Further, a UE may be configured to operate based on control information in TTI 210-a or based on multi-TTI control information, such as control information symbol 305-e. Whether a UE operates based on control information in TTI 210-a or according to a multi-TTI operation may be based on channel conditions. For example, a UE having relatively good channel conditions with a large data packet size may benefit from multi-TTI, while a UE with relatively bad channel conditions and small packets may benefit from scheduling based on control information of TTI 210-a.

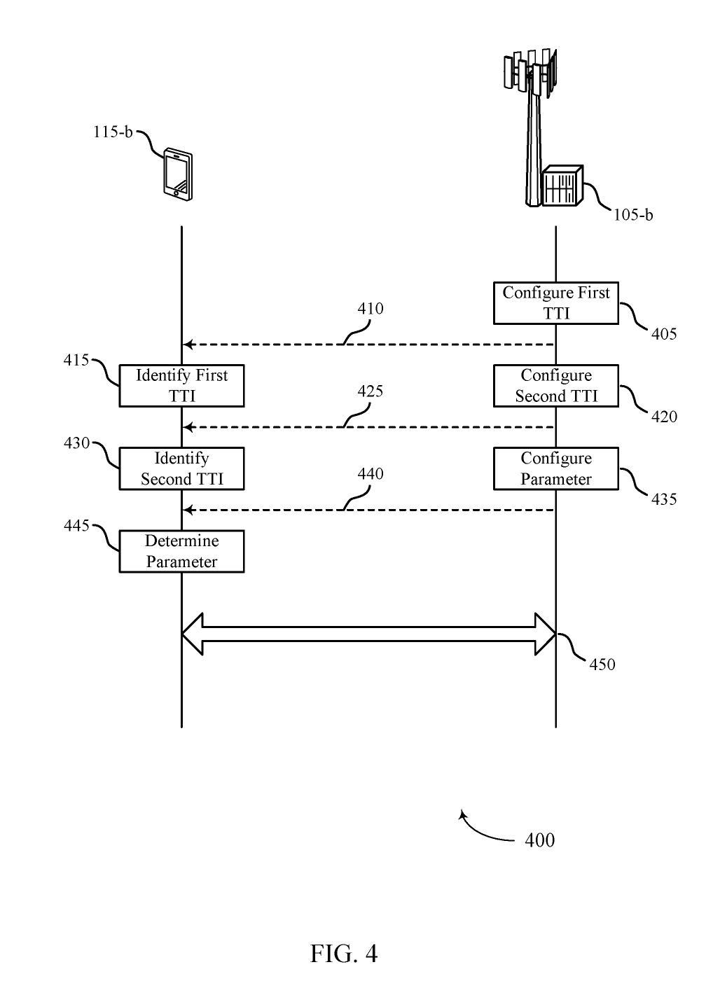

FIG. 4 illustrates an example of a process flow 400 for low latency control overhead reduction in accordance with various aspects of the present disclosure. Process flow 400 may include base station 105-b and UE 115-b, which may be examples of the corresponding devices described with reference to FIGS. 1-2. In multi-TTI operations, a base-station 105-b may configure a first TTI. The first TTI may include two or more symbol periods and the duration of the first TTI may depend on the number of symbol periods within the first TTI. The first TTI may be an example of TTI 210 as described with reference to FIG. 2. In some examples, the configuration of the first TTI may be transmitted from the base station 105-b to the UE 115-b, as shown by 410. At 415, the UE 115-b may identify the first TTI (e.g., based on the configuration transmitted by the base station at 410).

Base station 105-b may configure a second TTI at 420. The second TTI may include one or more symbol periods and the duration of the second TTI may depend on the location of the second TTI with respect to resources of the first TTI. The second TTI may have a duration shorter than the first TTI configured at 405. The second TTI may be an example of TTI 215 in FIG. 2 or TTIs 310 in FIG. 3. In some examples, the configuration of the second TTI may be transmitted from the base station 105-b to the UE 115-b, as shown by 425. At 430 the UE 115-b may identify the second TTI (e.g., based on the configuration transmitted by the base station at 425).

In some examples, base station 105-b may determine a parameter of the second TTI. For example, the base station 105-b may determine a TBS, number of TBs or TTIs, or MCS associated with multiple TTIs. The parameter may be determined based at least in part on a location (e.g., a starting time) of the second TTI (configured at 420) with respect to one or more symbols of the first TTI (configured at 405). In some examples, the determined parameter may be transmitted from the base station 105-b to the UE 115-b, as shown by 440. At 445 the UE 115-b may identify the determined parameter transmitted by the base station at 440. In other examples, the UE 115-b may determine a parameter based at least in part on the identified first and second TTIs. Thereafter, at 450, data may be exchanged between the UE 115-c and the base station 105-b. Data may be exchanged using the TTI identified in 415, the TTI identified in 430, or a combination thereof.

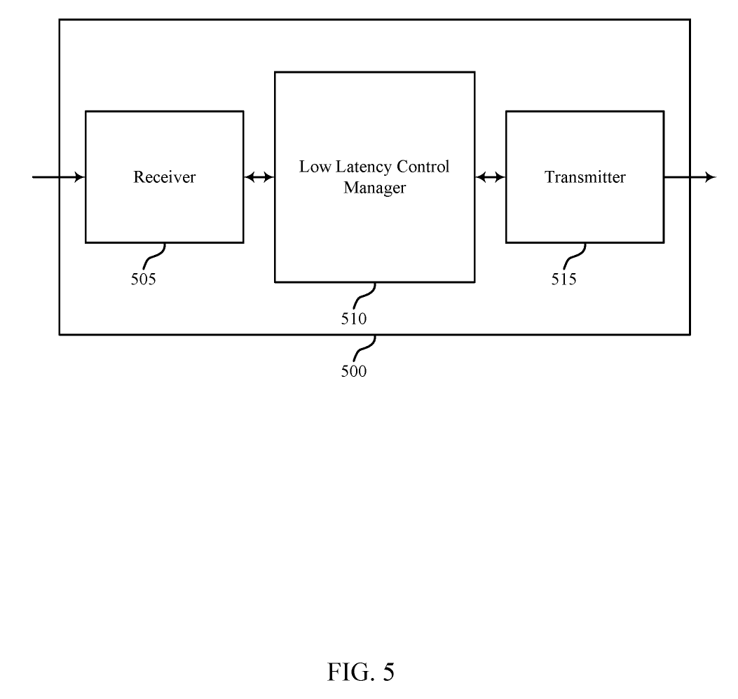

FIG. 5 shows a block diagram of a wireless device 500 that supports low latency control overhead reduction in accordance with various aspects of the present disclosure. Wireless device 500 may be an example of aspects of a UE 115 described with reference to FIGS. 1 and 2. Wireless device 500 may include receiver 505, low latency control manager 510, and transmitter 515. Wireless device 500 may also include a processor. Each of these components may be in communication with one another.

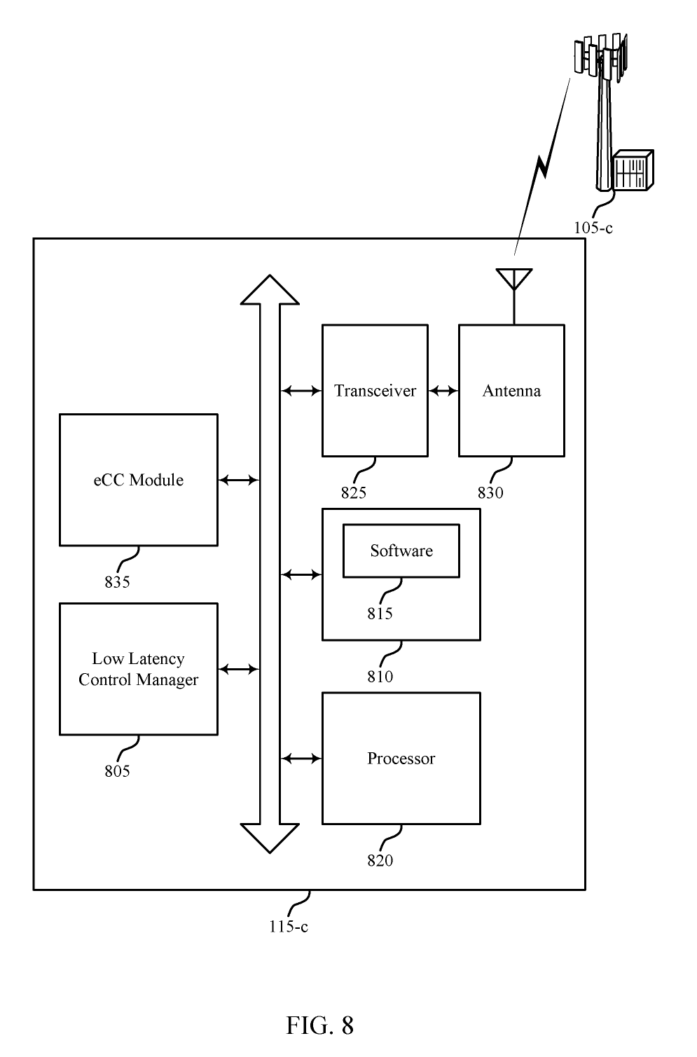

The receiver 505 may receive information such as packets, user data, or control information associated with various information channels (e.g., control channels, data channels, and information related to low latency control overhead reduction). Information may be passed on to other components of the device. The receiver 505 may be an example of aspects of the transceiver 825 described with reference to FIG. 8.

The low latency control manager 510 may identify a first TTI having a first duration that comprises two or more symbol periods, identify a second TTI having a second duration that is less than the first duration, determine a parameter of the second TTI based on a location (e.g., a starting time) of the second TTI with respect to the two or more symbol periods of the first TTI, and communicate during the second TTI according to the determined parameter of the second TTI. The low latency control manager 510 may also be an example of aspects of the low latency control manager 805 described with reference to FIG. 8.

The transmitter 515 may transmit signals received from other components of wireless device 500. In some examples, the transmitter 515 may be collocated with a receiver in a transceiver module. For example, the transmitter 515 may be an example of aspects of the transceiver 825 described with reference to FIG. 8. The transmitter 515 may include a single antenna, or it may include a plurality of antennas.

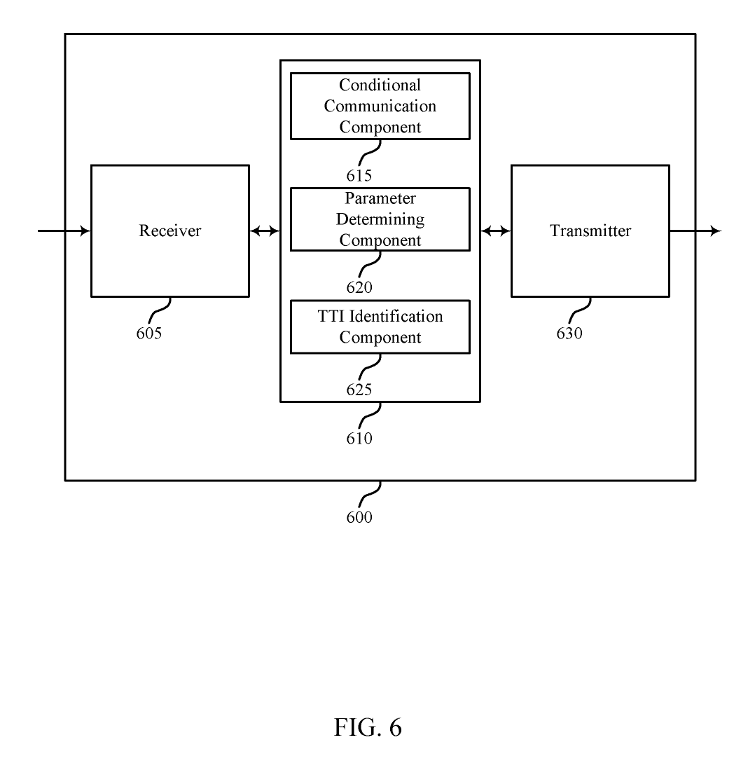

FIG. 6 shows a block diagram of a wireless device 600 that supports low latency control overhead reduction in accordance with various aspects of the present disclosure. Wireless device 600 may be an example of aspects of a wireless device 500 or a UE 115 described with reference to FIGS. 1, 2 and 5. Wireless device 600 may include receiver 605, low latency control manager 610, and transmitter 630. Wireless device 600 may also include a processor. Each of these components may be in communication with each other.

The receiver 605 may receive information which may be passed on to other components of the device. The receiver 605 may also perform the functions described with reference to the receiver 505 of FIG. 5. The receiver 605 may be an example of aspects of the transceiver 825 described with reference to FIG. 8.

The low latency control manager 610 may be an example of aspects of low latency control manager 510 described with reference to FIG. 5. The low latency control manager 610 may include conditional communication component 615, parameter determining component 620, and TTI identification component 625. The low latency control manager 610 may be an example of aspects of the low latency control manager 805 described with reference to FIG. 8.

The conditional communication component 615 may communicate during the second TTI or the third TTI, or both, using resources scheduled by the first control message, communicate during the second TTI using resources scheduled by the second control message, communicate during the third TTI according to the determined parameter of the third TTI, and communicate during the second TTI according to the determined parameter of the second TTI. In some cases, the second TTI and the third TTI each comprise portions of a same transport block. In some cases, the second TTI comprises a first repetition of a transport block and the third TTI comprises a second repetition of the transport block.

The parameter determining component 620 may determine a parameter of the third TTI based on a location (e.g. a starting time) of the third TTI with respect to the two or more symbol periods of the first TTI, and determine a parameter of the second TTI based on a location (e.g., a starting time) of the second TTI with respect to the two or more symbol periods of the first TTI. In some cases, the parameter of the second TTI is determined based on a symbol associated with the first TTI comprising a control message. In some cases, the determined parameter of the second TTI comprises a TBS or a MCS, or both.

The TTI identification component 625 may identify a third TTI having a third duration that is less than the first duration, identify a first TTI having a first duration that comprises two or more symbol periods, and identify a second TTI having a second duration that is less than the first duration. In some cases, a single transport block spans the second duration of the second TTI.

The transmitter 630 may transmit signals received from other components of wireless device 600. In some examples, the transmitter 630 may be collocated with a receiver in a transceiver module. For example, the transmitter 630 may be an example of aspects of the transceiver 825 described with reference to FIG. 8. The transmitter 630 may utilize a single antenna, or it may utilize a plurality of antennas.

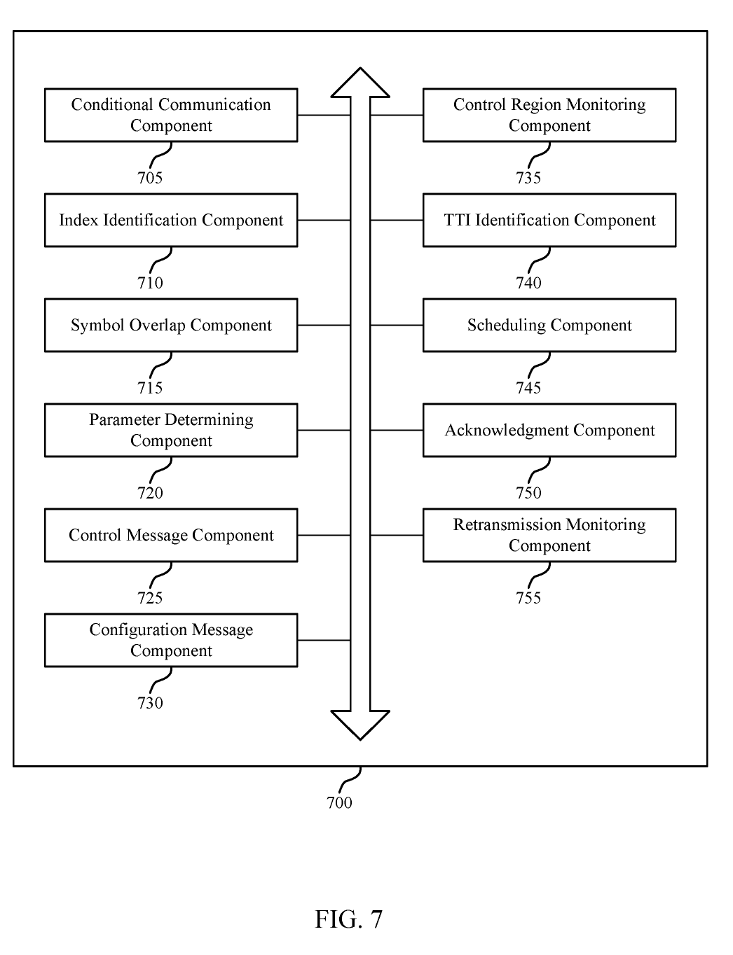

FIG. 7 shows a block diagram of a low latency control manager 700 which may be an example of the corresponding component of wireless device 500 or wireless device 600. That is, low latency control manager 700 may be an example of aspects of low latency control manager 510 or low latency control manager 610 described with reference to FIGS. 5 and 6. The low latency control manager 700 may also be an example of aspects of the low latency control manager 805 described with reference to FIG. 8.

The low latency control manager 700 may include conditional communication component 705, index identification component 710, symbol overlap component 715, parameter determining component 720, control message component 725, configuration message component 730, control region monitoring component 735, TTI identification component 740, scheduling component 745, acknowledgment component 750, and retransmission monitoring component 755. Each of these modules may communicate, directly or indirectly, with one another (e.g., via one or more buses).

The conditional communication component 705 may communicate during the second TTI or the third TTI, or both, using resources scheduled by the first control message, communicate during the second TTI using resources scheduled by the second control message, communicate during the third TTI according to the determined parameter of the third TTI, and communicate during the second TTI according to the determined parameter of the second TTI.

The index identification component 710 may identify an index for each symbol period of the two or more symbol periods of the first TTI, where the parameter of the second TTI is determined based on the location of the second TTI with respect to at least one of the identified indices.

The symbol overlap component 715 may determine that one or more symbols associated with the first TTI overlaps in time with the second TTI and comprises a reference signal, where the parameter of the second TTI is determined based on the determination that the one or more symbols of the first TTI comprises the reference signal.

The parameter determining component 720 may determine a parameter of the third TTI based on a location (e.g., a starting time) of the third TTI with respect to the two or more symbol periods of the first TTI, and determine a parameter of the second TTI based on a location of the second TTI with respect to the two or more symbol periods of the first TTI. In some cases, the parameter of the second TTI is determined based on one or more symbols associated with the first TTI comprising a reference signal. In some cases, the determined parameter of the second TTI comprises a TBS or a MCS, or both.

The control message component 725 may receive a first control message in a control region of the first TTI, where the first control message schedules resources during the second TTI or a third TTI, or both, receive a second control message during the second TTI, where the second control message schedules resources during the second TTI, and receive a second control message in the control region of the first TTI. In some cases, the second control message indicates a number of TTIs having the second duration that occurs within the first duration of the first TTI based on the first control message. In some cases, the second control message schedules resources during the third TTI, and wireless device 500 or 600 of which control message component 725 is an aspect may communicate during the third TTI using resources scheduled by the second control message. In some cases, the second TTI and the third TTI each comprise portions of a same transport block. In some cases, the second TTI comprises a first repetition of a transport block and the third TTI comprises a second repetition of the transport block.

In some cases, the first control message indicates a number of TTIs having the second duration that occurs within the first duration of the first TTI based on the first control message. In some cases, a control message that schedules the second TTI and the third TTI comprises a first indicator that the second TTI comprises new data and a second indicator that the third TTI comprises other new data. In some cases, a control message that schedules the second TTI and the third TTI comprises a common indicator that either the second TTI or the third TTI, or both, include new data.

The configuration message component 730 may receive a configuration message that identifies symbols associated with the first TTI that comprise reference signals, receive a configuration message that indicates that the first control message schedules resources of the second TTI or the third TTI, or both, receive a configuration message that indicates a number of second TTIs that have the second duration that occurs within the first duration of the first TTI, and receive a configuration message that indicates a number of TTIs having the second duration and a number of TTIs having the third duration that occur within the first duration of the first TTI. In some cases, a configuration indicated by the configuration message is based on a traffic condition or a channel condition, or both. In some cases, the configuration message is a two-bit indicator or a three-bit indicator that indicates the number of TTIs.

The control region monitoring component 735 may monitor the control region of the first TTI for the first control message based on receiving the configuration message, and monitor the control region of the first TTI for the first control message based on reception of the second control message.

The TTI identification component 740 may identify a third TTI having a third duration that is less than the first duration, identify a first TTI having a first duration that comprises two or more symbol periods, and identify a second TTI having a second duration that is less than the first duration. In some cases, a single transport block spans the second duration of the second TTI.

The scheduling component 745 may receive a message that schedules resources for periodic transmissions, where resources scheduled for each transmission opportunity comprise two or more TTIs having the second duration, and where a single transport block spans the second duration of each TTI of the two or more TTIs.

The acknowledgment component 750 may transmit a negative acknowledgment message for data associated with the second TTI. The retransmission monitoring component 755 may monitor for a retransmission of the data associated with the second TTI according to a fixed retransmission timing.

FIG. 8 shows a diagram of a system 800 including a device that supports low latency control overhead reduction in accordance with various aspects of the present disclosure. For example, system 800 may include UE 115-c, which may be an example of a wireless device 500, a wireless device 600, or a UE 115 as described with reference to FIGS. 1, 2 and 5 through 7. System 800 may include base station 105-c, which may be an example of a base station 105 as described with reference to FIGS. 1 and 2.

UE 115-c may also include low latency control manager 805, memory 810, processor 820, transceiver 825, antenna 830 and eCC module 835. Each of these modules may communicate, directly or indirectly, with one another (e.g., via one or more buses). The low latency control manager 805 may be an example of a low latency control manager as described with reference to FIGS. 5 through 7.

The memory 810 may include random access memory (RAM) and read only memory (ROM). The memory 810 may store computer-readable, computer-executable software including instructions that, when executed, cause the processor to perform various functions described herein (e.g., low latency control overhead reduction). In some cases, the software 815 may not be directly executable by the processor but may cause a computer (e.g., when compiled and executed) to perform functions described herein. The processor 820 may include an intelligent hardware device, (e.g., a central processing unit (CPU), a microcontroller, an application specific integrated circuit (ASIC)).

The transceiver 825 may communicate bi-directionally, via one or more antennas, wired, or wireless links, with one or more networks, as described above. For example, the transceiver 825 may communicate bi-directionally with a base station 105 or a UE 115. The transceiver 825 may also include a modem to modulate the packets and provide the modulated packets to the antennas for transmission, and to demodulate packets received from the antennas. In some cases, the wireless device may include a single antenna 830. However, in some cases the device may have more than one antenna 830, which may be capable of concurrently transmitting or receiving multiple wireless transmissions.

The eCC module 835 may enable operations using eCCs such as communication using shared or unlicensed spectrum, using reduced TTIs or subframe durations, or using a large number of CCs.

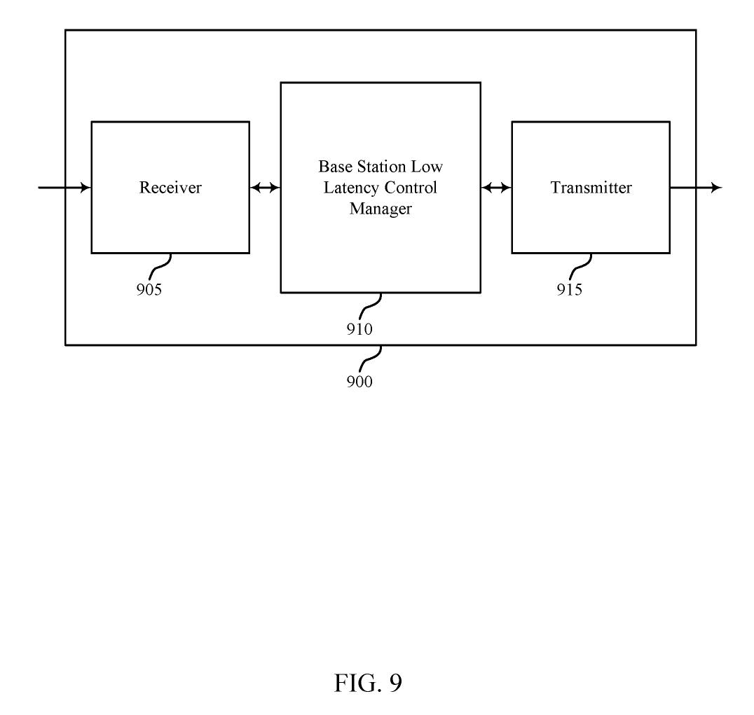

FIG. 9 shows a block diagram of a wireless device 900 that supports low latency control overhead reduction in accordance with various aspects of the present disclosure. Wireless device 900 may be an example of aspects of a base station 105 described with reference to FIGS. 1 and 2. Wireless device 900 may include receiver 905, base station low latency control manager 910 and transmitter 915. Wireless device 900 may also include a processor. Each of these components may be in communication with each other.

The receiver 905 may receive information such as packets, user data, or control information associated with various information channels (e.g., control channels, data channels, and information related to low latency control overhead reduction). Information may be passed on to other components of the device. The receiver 905 may be an example of aspects of the transceiver 1225 described with reference to FIG. 12.

The base station low latency control manager 910 may configure a first TTI having a first duration that comprises two or more symbol periods, configure a second TTI having a second duration that is less than the first duration, configure a parameter of the second TTI based on a location (e.g., a starting time) of the second TTI with respect to the two or more symbol periods of the first TTI, indicate the parameter to a UE, and communicate during the second TTI according to the configured parameter of the second TTI. The base station low latency control manager 910 may also be an example of aspects of the base station low latency control manager 1205 described with reference to FIG. 12.

The transmitter 915 may transmit signals received from other components of wireless device 900. In some examples, the transmitter 915 may be collocated with a receiver in a transceiver module. For example, the transmitter 915 may be an example of aspects of the transceiver 1225 described with reference to FIG. 12. The transmitter 915 may include a single antenna, or it may include a plurality of antennas.

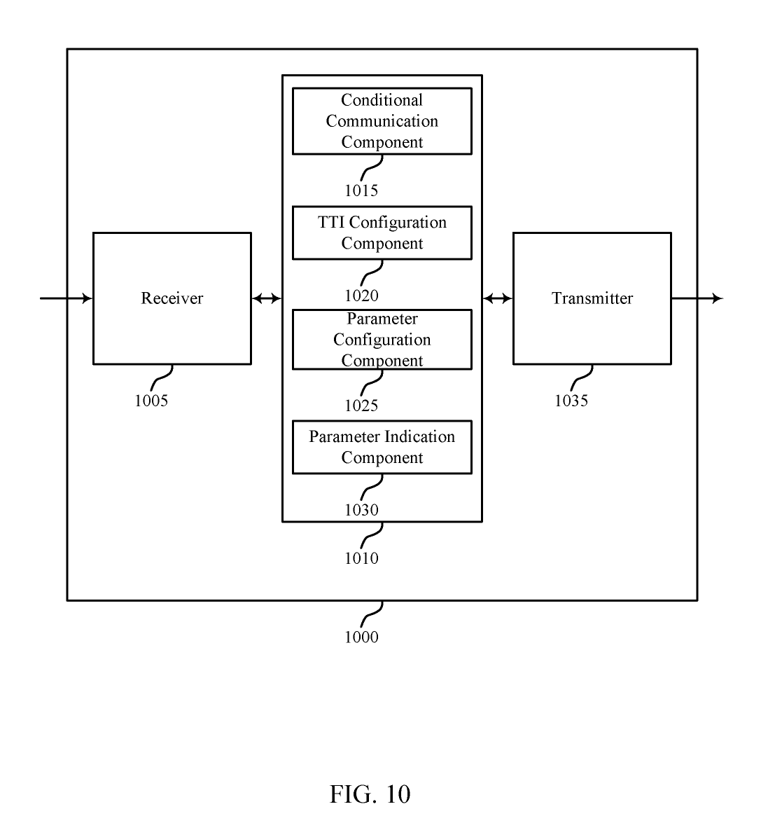

FIG. 10 shows a block diagram of a wireless device 1000 that supports low latency control overhead reduction in accordance with various aspects of the present disclosure. Wireless device 1000 may be an example of aspects of a wireless device 900 or a base station 105 described with reference to FIGS. 1, 2 and 9. Wireless device 1000 may include receiver 1005, base station low latency control manager 1010 and transmitter 1035. Wireless device 1000 may also include a processor. Each of these components may be in communication with each other.

The receiver 1005 may receive information which may be passed on to other components of the device. The receiver 1005 may also perform the functions described with reference to the receiver 905 of FIG. 9. The receiver 1005 may be an example of aspects of the transceiver 1225 described with reference to FIG. 12.

The base station low latency control manager 1010 may be an example of aspects of base station low latency control manager 910 described with reference to FIG. 9. The base station low latency control manager 1010 may include conditional communication component 1015, TTI configuration component 1020, parameter configuration component 1025, and parameter indication component 1030. The base station low latency control manager 1010 may be an example of aspects of the base station low latency control manager 1205 described with reference to FIG. 12.

The conditional communication component 1015 may communicate during the second TTI according to the configured parameter of the second TTI, communicate during the second TTI or the third TTI, or both, using resources scheduled by the first control message, and communicate during the second TTI using resources scheduled by the second control message.

The TTI configuration component 1020 may configure a first TTI having a first duration that comprises two or more symbol periods, and configure a second TTI having a second duration that is less than the first duration.

The parameter configuration component 1025 may configure a parameter of the second TTI based on a location (e.g., a starting time) of the second TTI with respect to the two or more symbol periods of the first TTI. The parameter indication component 1030 may indicate the parameter to a UE.

The transmitter 1035 may transmit signals received from other components of wireless device 1000. In some examples, the transmitter 1035 may be collocated with a receiver in a transceiver module. For example, the transmitter 1035 may be an example of aspects of the transceiver 1225 described with reference to FIG. 12. The transmitter 1035 may utilize a single antenna, or it may utilize a plurality of antennas.

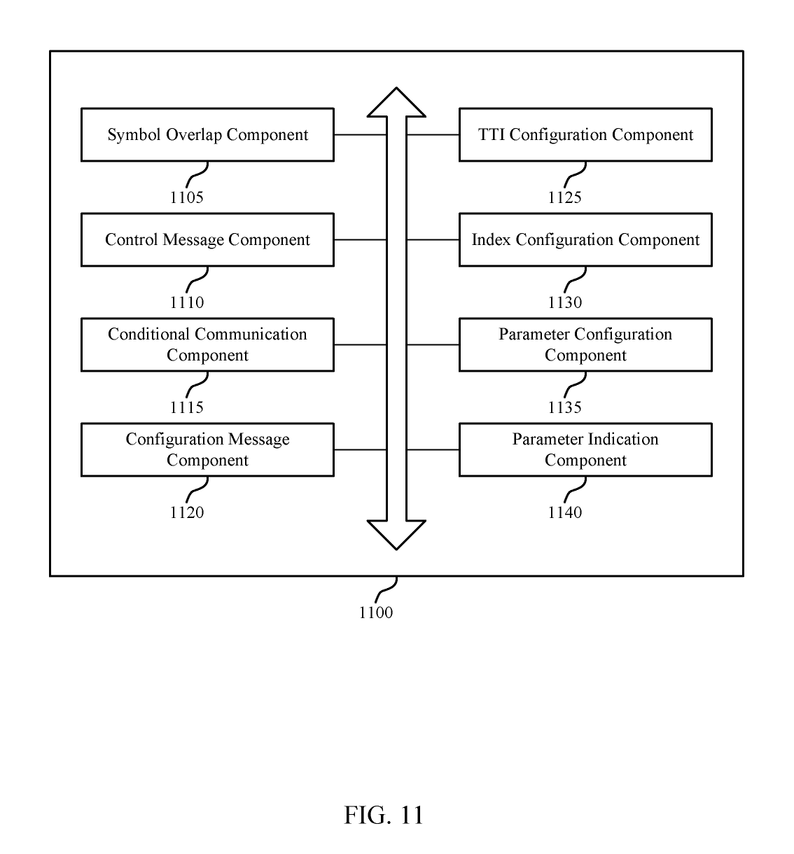

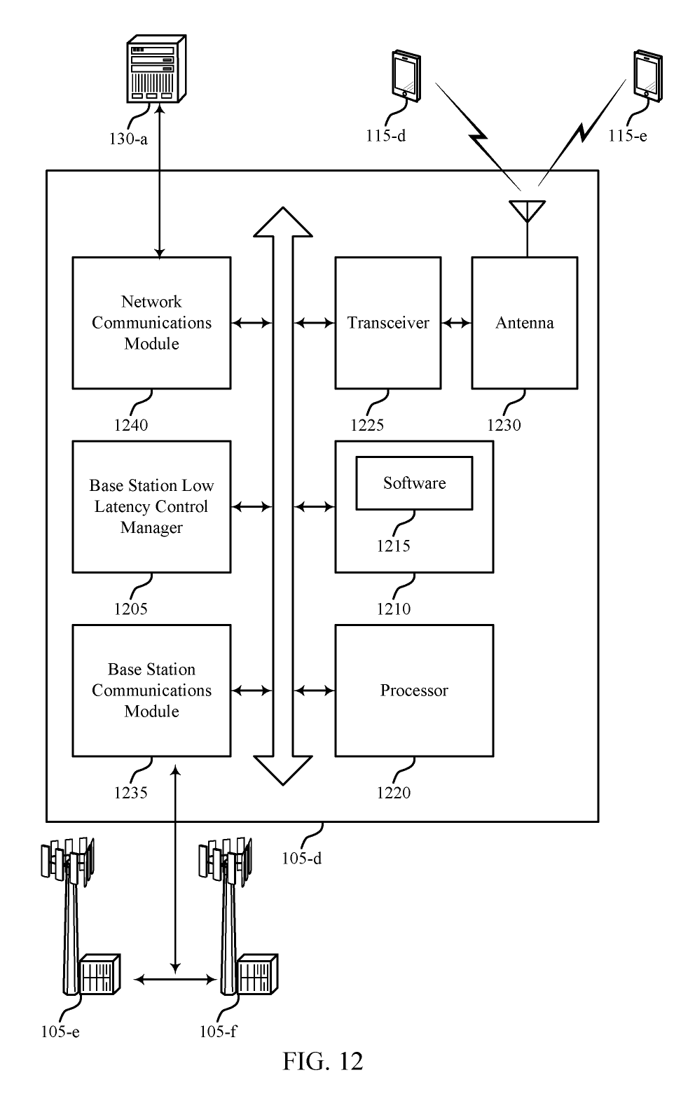

FIG. 11 shows a block diagram of a base station low latency control manager 1100 which may be an example of the corresponding component of wireless device 900 or wireless device 1000. That is, base station low latency control manager 1100 may be an example of aspects of base station low latency control manager 910 or base station low latency control manager 1010 described with reference to FIGS. 9 and 10. The base station low latency control manager 1100 may also be an example of aspects of the base station low latency control manager 1205 described with reference to FIG. 12.

The base station low latency control manager 1100 may include symbol overlap component 1105, control message component 1110, conditional communication component 1115, configuration message component 1120, TTI configuration component 1125, index configuration component 1130, parameter configuration component 1135 and parameter indication component 1140. Each of these modules may communicate, directly or indirectly, with one another (e.g., via one or more buses).

The symbol overlap component 1105 may determine that one or more symbols associated with the first TTI overlaps in time the second TTI and comprises a reference signal, where the parameter of the second TTI is configured based on whether the one or more symbols of the first TTI comprises the reference signal.

The control message component 1110 may transmit a first control message in a control region of the first TTI, where the first control message schedules resources during the second TTI or a third TTI, or both, transmit a second control message during the second TTI, where the second control message schedules resources during the second TTI, and transmit the first control message in the control region of the first TTI.

The conditional communication component 1115 may communicate during the second TTI according to the configured parameter of the second TTI, communicate during the second TTI or the third TTI, or both, using resources scheduled by the first control message, and communicate during the second TTI using resources scheduled by the second control message.

The configuration message component 1120 may transmit a configuration message that indicates that the first control message schedules resources of the second TTI or the third TTI, or both, and transmit a configuration message that indicates a number of TTIs having the second duration that occurs within the first duration of the first TTI.

The TTI configuration component 1125 may configure a first TTI having a first duration that comprises two or more symbol periods, and configure a second TTI having a second duration that is less than the first duration.

The index configuration component 1130 may configure an index for each symbol period of the two or more symbol periods of the first TTI, where the parameter of the second TTI is configured based on the location of the second TTI with respect to at least one of the identified indices.

The parameter configuration component 1135 may configure a parameter of the second TTI based on a location (e.g., a starting time) of the second TTI with respect to the two or more symbol periods of the first TTI. The parameter indication component 1140 may indicate the parameter to a UE.

FIG. 12 shows a diagram of a wireless system 1200 including a device configured that supports low latency control overhead reduction in accordance with various aspects of the present disclosure. For example, system 1200 may include base station 105-d, which may be an example of a wireless device 900, a wireless device 1000, or a base station 105 as described with reference to FIGS. 1, 2 and 9 through 11. Base station 105-d may also include components for bi-directional voice and data communications including components for transmitting communications and components for receiving communications. For example, base station 105-d may communicate bi-directionally with one or more UEs 115 (e.g., UE 115-d and UE 115-e).

Base station 105-d may also include base station low latency control manager 1205, memory 1210, processor 1220, transceiver 1225, antenna 1230, base station communications module 1235 and network communications module 1240. Each of these modules may communicate, directly or indirectly, with one another (e.g., via one or more buses). The base station low latency control manager 1205 may be an example of a base station low latency control manager as described with reference to FIGS. 9 through 11.

The memory 1210 may include RAM and ROM. The memory 1210 may store computer-readable, computer-executable software including instructions that, when executed, cause the processor to perform various functions described herein (e.g., low latency control overhead reduction). In some cases, the software 1215 may not be directly executable by the processor but may cause a computer (e.g., when compiled and executed) to perform functions described herein. The processor 1220 may include an intelligent hardware device, (e.g., a CPU, a microcontroller, an ASIC).

The transceiver 1225 may communicate bi-directionally, via one or more antennas, wired, or wireless links, with one or more networks, as described above. For example, the transceiver 1225 may communicate bi-directionally with a base station 105 or a UE 115. The transceiver 1225 may also include a modem to modulate the packets and provide the modulated packets to the antennas for transmission, and to demodulate packets received from the antennas. In some cases, the wireless device may include a single antenna 1230. However, in some cases the device may have more than one antenna 830, which may be capable of concurrently transmitting or receiving multiple wireless transmissions.

The base station communications module 1235 may manage communications with other base stations 105 (e.g., base stations 105-e and 105-f), and may include a controller or scheduler for controlling communications with UEs 115 in cooperation with other base stations 105. For example, the base station communications module 1235 may coordinate scheduling for transmissions to UEs 115 for various interference mitigation techniques such as beamforming or joint transmission. In some examples, base station communications module 1235 may provide an X2 interface within an LTE/LTE-A wireless communication network technology to provide communication between base stations 105.

The network communications module 1240 may manage communications with the core network (e.g., via one or more wired backhaul links). For example, the network communications module 1240 may manage the transfer of data communications for client devices, such as one or more UEs 115.

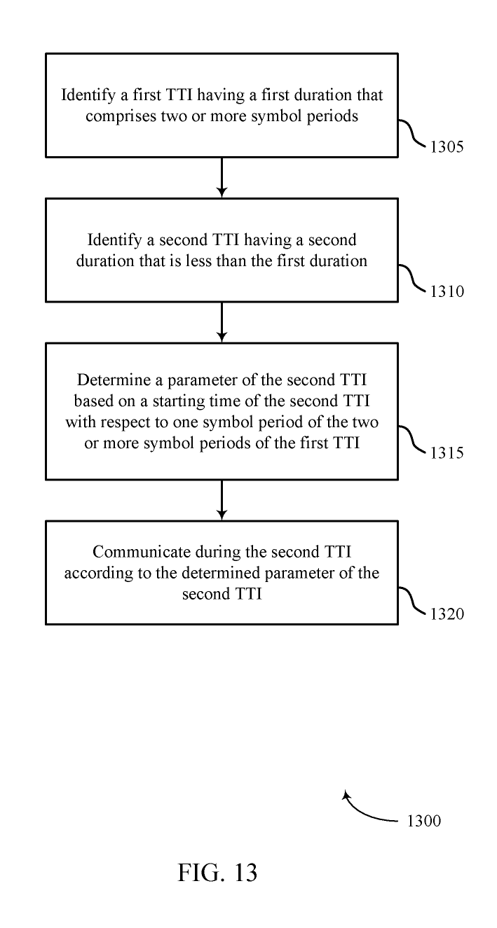

FIG. 13 shows a flowchart illustrating a method 1300 for low latency control overhead reduction in accordance with various aspects of the present disclosure. The operations of method 1300 may be implemented by a device such as a UE 115 or its components as described with reference to FIGS. 1, 2, and 5 through 8. For example, the operations of method 1300 may be performed by the low latency control manager as described herein. In some examples, the UE 115 may execute a set of codes to control the functional elements of the device to perform the functions described below. Additionally or alternatively, the UE 115 may perform aspects of the functions described below using special-purpose hardware.

At block 1305, the UE 115 may identify a first TTI having a first duration that comprises two or more symbol periods as described above with reference to FIGS. 2 through 4. In certain examples, the operations of block 1305 may be performed by the TTI identification component as described with reference to FIGS. 6 and 7.

At block 1310, the UE 115 may identify a second TTI having a second duration that is less than the first duration as described above with reference to FIGS. 2 through 4. In certain examples, the operations of block 1310 may be performed by the TTI identification component as described with reference to FIGS. 6 and 7.

At block 1315, the UE 115 may determine a parameter of the second TTI based on a location of the second TTI with respect to the two or more symbol periods of the first TTI as described above with reference to FIGS. 2 through 4. For example, the parameter of the second TTI may be determined based on starting time of the second TTI with respect to one symbol period of the two or more symbol periods of the first TTI. In certain examples, the operations of block 1315 may be performed by the parameter determining component as described with reference to FIGS. 6 and 7.

At block 1320, the UE 115 may communicate during the second TTI according to the determined parameter of the second TTI as described above with reference to FIGS. 2 through 4. In certain examples, the operations of block 1320 may be performed by the conditional communication component as described with reference to FIGS. 6 and 7.

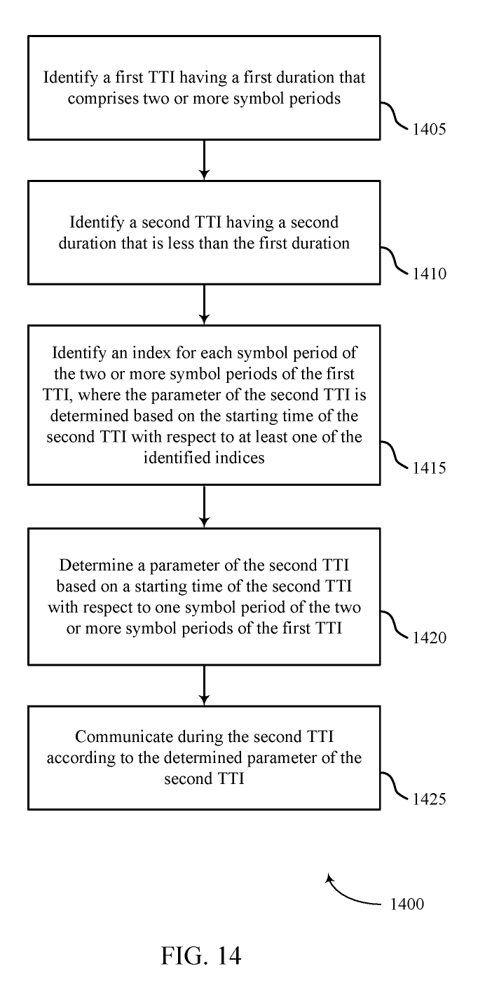

FIG. 14 shows a flowchart illustrating a method 1400 for low latency control overhead reduction in accordance with various aspects of the present disclosure. The operations of method 1400 may be implemented by a device such as a UE 115 or its components as described with reference to FIGS. 1, 2, and 5 through 8. For example, the operations of method 1400 may be performed by the low latency control manager as described herein. In some examples, the UE 115 may execute a set of codes to control the functional elements of the device to perform the functions described below. Additionally or alternatively, the UE 115 may perform aspects of the functions described below using special-purpose hardware.

At block 1405, the UE 115 may identify a first TTI having a first duration that comprises two or more symbol periods as described above with reference to FIGS. 2 through 4. In certain examples, the operations of block 1405 may be performed by the TTI identification component as described with reference to FIGS. 6 and 7.

At block 1410, the UE 115 may identify a second TTI having a second duration that is less than the first duration as described above with reference to FIGS. 2 through 4. In certain examples, the operations of block 1410 may be performed by the TTI identification component as described with reference to FIGS. 6 and 7.

At block 1415, the UE 115 may identify an index for each symbol period of the two or more symbol periods of the first TTI, where the parameter of the second TTI is determined based on a location of the second TTI with respect to at least one of the identified indices as described above with reference to FIGS. 2 through 4. In certain examples, the operations of block 1415 may be performed by the index identification component as described with reference to FIGS. 6 and 7.

At block 1420, the UE 115 may determine a parameter of the second TTI based on the location of the second TTI with respect to the two or more symbol periods of the first TTI as described above with reference to FIGS. 2 through 4. In certain examples, the operations of block 1420 may be performed by the parameter determining component as described with reference to FIGS. 6 and 7.

At block 1425, the UE 115 may communicate during the second TTI according to the determined parameter of the second TTI as described above with reference to FIGS. 2 through 4. In certain examples, the operations of block 1425 may be performed by the conditional communication component as described with reference to FIGS. 6 and 7.

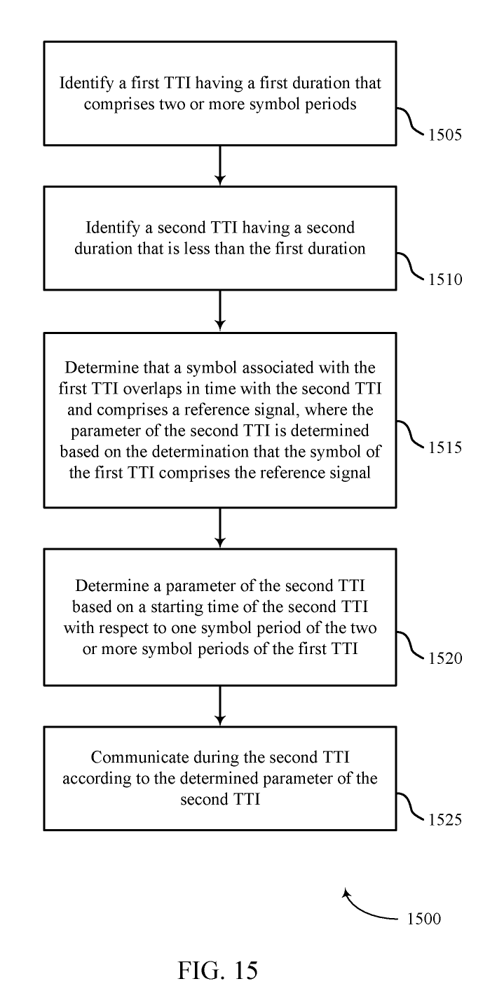

FIG. 15 shows a flowchart illustrating a method 1500 for low latency control overhead reduction in accordance with various aspects of the present disclosure. The operations of method 1500 may be implemented by a device such as a UE 115 or its components as described with reference to FIGS. 1, 2, and 5 through 8. For example, the operations of method 1500 may be performed by the low latency control manager as described herein. In some examples, the UE 115 may execute a set of codes to control the functional elements of the device to perform the functions described below. Additionally or alternatively, the UE 115 may perform aspects of the functions described below using special-purpose hardware.

At block 1505, the UE 115 may identify a first TTI having a first duration that comprises two or more symbol periods as described above with reference to FIGS. 2 through 4. In certain examples, the operations of block 1505 may be performed by the TTI identification component as described with reference to FIGS. 6 and 7.

At block 1510, the UE 115 may identify a second TTI having a second duration that is less than the first duration as described above with reference to FIGS. 2 through 4. In certain examples, the operations of block 1510 may be performed by the TTI identification component as described with reference to FIGS. 6 and 7.

At block 1515, the UE 115 may determine that one or more symbols associated with the first TTI overlaps in time with the second TTI and comprises a reference signal, where the parameter of the second TTI is determined based on the determination that the one or more symbols of the first TTI comprises the reference signal as described above with reference to FIGS. 2 through 4. In certain examples, the operations of block 1515 may be performed by the symbol overlap component as described with reference to FIGS. 6 and 7.

At block 1520, the UE 115 may determine a parameter of the second TTI based on a location of the second TTI with respect to the two or more symbol periods of the first TTI as described above with reference to FIGS. 2 through 4. In certain examples, the operations of block 1520 may be performed by the parameter determining component as described with reference to FIGS. 6 and 7.

At block 1525, the UE 115 may communicate during the second TTI according to the determined parameter of the second TTI as described above with reference to FIGS. 2 through 4. In certain examples, the operations of block 1525 may be performed by the conditional communication component as described with reference to FIGS. 6 and 7.

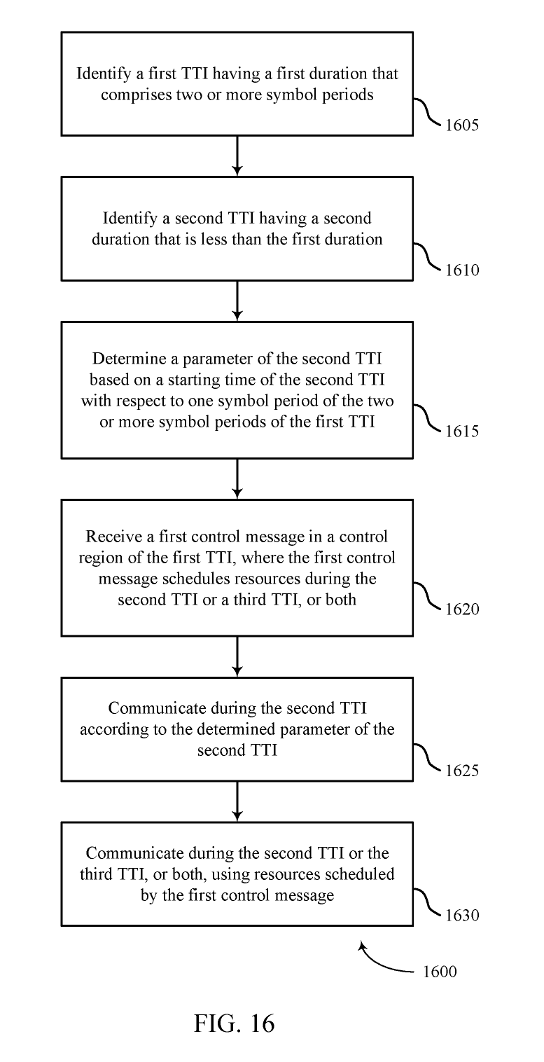

FIG. 16 shows a flowchart illustrating a method 1600 for low latency control overhead reduction in accordance with various aspects of the present disclosure. The operations of method 1600 may be implemented by a device such as a UE 115 or its components as described with reference to FIGS. 1, 2, and 5 through 8. For example, the operations of method 1600 may be performed by the low latency control manager as described herein. In some examples, the UE 115 may execute a set of codes to control the functional elements of the device to perform the functions described below. Additionally or alternatively, the UE 115 may perform aspects of the functions described below using special-purpose hardware.

At block 1605, the UE 115 may identify a first TTI having a first duration that comprises two or more symbol periods as described above with reference to FIGS. 2 through 4. In certain examples, the operations of block 1605 may be performed by the TTI identification component as described with reference to FIGS. 6 and 7.

At block 1610, the UE 115 may identify a second TTI having a second duration that is less than the first duration as described above with reference to FIGS. 2 through 4. In certain examples, the operations of block 1610 may be performed by the TTI identification component as described with reference to FIGS. 6 and 7.

At block 1615, the UE 115 may determine a parameter of the second TTI based on a location of the second TTI with respect to the two or more symbol periods of the first TTI as described above with reference to FIGS. 2 through 4. In certain examples, the operations of block 1615 may be performed by the parameter determining component as described with reference to FIGS. 6 and 7.

At block 1620, the UE 115 may receive a first control message in a control region of the first TTI, where the first control message schedules resources during the second TTI or a third TTI, or both as described above with reference to FIGS. 2 through 4. In some cases, the second TTI and the third TTI each comprise portions of a same transport block. In some cases, the second TTI comprises a first repetition of a transport block and the third TTI comprises a second repetition of the transport block. In certain examples, the operations of block 1620 may be performed by the control message component as described with reference to FIGS. 6 and 7.

At block 1625, the UE 115 may communicate during the second TTI according to the determined parameter of the second TTI as described above with reference to FIGS. 2 through 4. In certain examples, the operations of block 1625 may be performed by the conditional communication component as described with reference to FIGS. 6 and 7.

At block 1630, the UE 115 may communicate during the second TTI or the third TTI, or both, using resources scheduled by the first control message as described above with reference to FIGS. 2 through 4. In certain examples, the operations of block 1630 may be performed by the conditional communication component as described with reference to FIGS. 6 and 7.

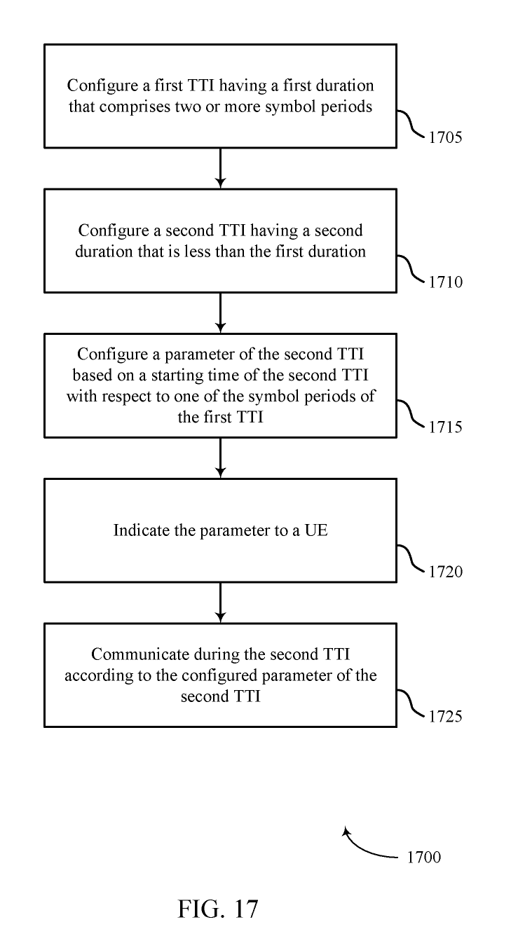

FIG. 17 shows a flowchart illustrating a method 1700 for low latency control overhead reduction in accordance with various aspects of the present disclosure. The operations of method 1700 may be implemented by a device such as a base station 105 or its components as described with reference to FIGS. 1, 2, and 9 through 12. For example, the operations of method 1700 may be performed by the base station low latency control manager as described herein. In some examples, the base station 105 may execute a set of codes to control the functional elements of the device to perform the functions described below. Additionally or alternatively, the base station 105 may perform aspects of the functions described below using special-purpose hardware.

At block 1705, the base station 105 may configure a first TTI having a first duration that comprises two or more symbol periods as described above with reference to FIGS. 2 through 4. In certain examples, the operations of block 1705 may be performed by the TTI configuration component as described with reference to FIGS. 10 and 11.

At block 1710, the base station 105 may configure a second TTI having a second duration that is less than the first duration as described above with reference to FIGS. 2 through 4. In certain examples, the operations of block 1710 may be performed by the TTI configuration component as described with reference to FIGS. 10 and 11.

At block 1715, the base station 105 may configure a parameter of the second TTI based on a location of the second TTI with respect to the two or more symbol periods of the first TTI as described above with reference to FIGS. 2 through 4. In certain examples, the operations of block 1715 may be performed by the parameter configuration component as described with reference to FIGS. 10 and 11.

At block 1720, the base station 105 may indicate the parameter to a UE as described above with reference to FIGS. 2 through 4. In certain examples, the operations of block 1720 may be performed by the parameter indication component as described with reference to FIGS. 10 and 11.

At block 1725, the base station 105 may communicate during the second TTI according to the configured parameter of the second TTI as described above with reference to FIGS. 2 through 4. In certain examples, the operations of block 1725 may be performed by the conditional communication component as described with reference to FIGS. 10 and 11.

It should be noted that these methods describe possible implementation, and that the operations and the steps may be rearranged or otherwise modified such that other implementations are possible. In some examples, aspects from two or more of the methods 1300, 1400, 1500, 1600, and 1700 described with reference to FIG. 13, 14, 15, 16, or 17 may be combined. For example, aspects of each of the methods may include steps or aspects of the other methods, or other steps or techniques described herein. Thus, aspects of the disclosure may provide for low latency control overhead reduction.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but are to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C) as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies. In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels), overhead information, user data, etc. The communication links described herein (e.g., communication links 125 of FIG. 1) may transmit bidirectional communications using frequency division duplex (FDD) (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for low latency control overhead reduction. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

What is claimed is:

1. A method for wireless communication, comprising:
identifying a first transmission time interval (TTI) having a first duration that comprises two or more symbol periods;
identifying a second TTI having a second duration that is less than the first duration;
determining a parameter of the second TTI based at least in part on a location of the second TTI with respect to the two or more symbol periods of the first TTI; and
communicating during the second TTI according to the determined parameter of the second TTI.

2. The method of claim 1, wherein the determined parameter of the second TTI comprises a transport block size or a modulation and coding scheme, or both.

3. The method of claim 1, wherein a single transport block spans the second duration of the second TTI.

4. The method of claim 1, further comprising:
identifying an index for each symbol period of the two or more symbol periods of the first TTI, wherein the parameter of the second TTI is determined based at least in part on the location of the second TTI with respect to at least one of the identified indices.

5. The method of claim 1, further comprising:
determining that a symbol associated with the first TTI overlaps in time with the second TTI and comprises a reference signal, wherein the parameter of the second TTI is determined based at least in part on the determination that the symbol associated with the first TTI comprises the reference signal.

6. The method of claim 5, further comprising:
receiving a configuration message that identifies one or more symbols associated with the first TTI that comprises the reference signal.

7. The method of claim 1, wherein the parameter of the second TTI is determined based at least in part on a symbol associated with the first TTI comprising a control message.

8. The method of claim 1, further comprising:
receiving a first control message in a control region of the first TTI, wherein the first control message schedules resources during the second TTI or a third TTI, or both; and
communicating during the second TTI or the third TTI, or both, using resources scheduled by the first control message.

9. The method of claim 8, further comprising:
receiving a second control message during the second TTI, wherein the second control message schedules resources during the second TTI; and
communicating during the second TTI using resources scheduled by the second control message.

10. The method of claim 8, wherein:
the first control message schedules resources during the second TTI and the third TTI; and
the second TTI and the third TTI each comprise portions of a same transport block.

11. The method of claim 8, wherein:
the first control message schedules resources during the second TTI and the third TTI; and
the second TTI comprises a first repetition of a transport block and the third TTI comprises a second repetition of the transport block.

12. The method of claim 8, further comprising:
receiving a configuration message that indicates that the first control message schedules resources of the second TTI or the third TTI, or both; and
monitoring the control region of the first TTI for the first control message based at least in part on receiving the configuration message.

13. The method of claim 1, further comprising:
receiving a configuration message that indicates a number of second TTIs that have the second duration that occurs within the first duration of the first TTI.

14. The method of claim 1, further comprising:
identifying a third TTI having a third duration that is less than the first duration;
determining a parameter of the third TTI based at least in part on a location of the third TTI with respect the two or more symbol periods of the first TTI; and
communicating during the third TTI according to the determined parameter of the third TTI.

15. The method of claim 14, wherein a control message that schedules the second TTI and the third TTI comprises a first indicator that the second TTI comprises new data and a second indicator that the third TTI comprises other new data.

16. The method of claim 14, wherein a control message that schedules the second TTI and the third TTI comprises a common indicator that either the second TTI or the third TTI, or both, include new data.

17. The method of claim 14, further comprising:
receiving a configuration message that indicates a number of TTIs having the second duration and a number of TTIs having the third duration that occur within the first duration of the first TTI.

18. The method of claim 1, further comprising:
receiving a message that schedules resources for periodic transmissions, wherein resources scheduled for each transmission opportunity comprise two or more TTIs having the second duration, and wherein a single transport block spans the second duration of each TTI of the two or more TTIs.

19. The method of claim 1, further comprising:
transmitting a negative acknowledgment message for data associated with the second TTI; and
monitoring for a retransmission of the data associated with the second TTI according to a fixed retransmission timing.

20. An apparatus for wireless communication comprising:
means for identifying a first transmission time interval (TTI) having a first duration that comprises two or more symbol periods;
means for identifying a second TTI having a second duration that is less than the first duration;
means for determining a parameter of the second TTI based at least in part on a location of the second TTI with respect to the two or more symbol periods of the first TTI; and
means for communicating during the second TTI according to a determined parameter of the second TTI.

21. The apparatus of claim 20, further comprising:
means for identifying an index for each symbol period of the two or more symbol periods of the first TTI, wherein the parameter of the second TTI is determined based at least in part on the location of the second TTI with respect to at least one of the indices.

22. The apparatus of claim 20, further comprising:
means for receiving a first control message in a control region of the first TTI, wherein the first control message schedules resources during the second TTI or a third TTI, or both; and
means for communicating during the second TTI or the third TTI, or both, using resources scheduled by the first control message.

23. An apparatus for wireless communication, comprising:
a processor;
memory in electronic communication with the processor; and
instructions stored in the memory and operable, when executed by the processor, to cause the apparatus to:
identify a first transmission time interval (TTI) having a first duration that comprises two or more symbol periods;
identify a second TTI having a second duration that is less than the first duration;
determine a parameter of the second TTI based at least in part on a location of the second TTI with respect to the two or more symbol periods of the first TTI; and
communicate during the second TTI according to a determined parameter of the second TTI.

24. The apparatus of claim 23, wherein the instructions are further operable to cause the apparatus to:
identify an index for each symbol period of the two or more symbol periods of the first TTI; and
determine the parameter of the second TTI based at least in part on the location of the second TTI with respect to at least one of the indices.

25. The apparatus of claim 23, wherein the instructions are further operable to cause the apparatus to:
receive a first control message in a control region of the first TTI, wherein the first control message schedules resources during the second TTI or a third TTI, or both; and
communicate during the second TTI or the third TTI, or both, using resources scheduled by the first control message.

26. The apparatus of claim 23, wherein the instructions are further operable to cause the apparatus to:
identify a third TTI having a third duration that is less than the first duration;
determine a parameter of the third TTI based at least in part on a location of the third TTI with respect the two or more symbol periods of the first TTI; and
communicate during the third TTI according to a determined parameter of the third TTI.

27. The apparatus of claim 23, wherein the instructions are further operable to cause the apparatus to:
determine that a symbol associated with the first TTI overlaps in time with the second TTI and comprises a reference signal; and
determine the parameter of the second TTI based at least in part on a determination that the symbol associated with the first TTI comprises the reference signal.

28. A non-transitory computer-readable medium storing code for wireless communication, the code comprising instructions executable to:
identify a first transmission time interval (TTI) having a first duration that comprises two or more symbol periods;
identify a second TTI having a second duration that is less than the first duration;
determine a parameter of the second TTI based at least in part on a location of the second TTI with respect to the two or more symbol periods of the first TTI; and
communicate during the second TTI according to a determined parameter of the second TTI.

29. The non-transitory computer-readable medium of claim 28, wherein the code further comprises instructions executable to:
identify an index for each symbol period of the two or more symbol periods of the first TTI; and
determine the parameter of the second TTI based at least in part on the location of the second TTI with respect to at least one of the indices.

30. The non-transitory computer-readable medium of claim 28, wherein the code further comprises instructions executable to:
receive a first control message in a control region of the first TTI, wherein the first control message schedules resources during the second TTI or a third TTI, or both; and
communicate during the second TTI or the third TTI, or both, using resources scheduled by the first control message.
